(19) United States
(12) Patent Application Publication
(10) Pub. No.: US 2017/0337505 A1
(43) Pub. Date: Nov. 23, 2017

(54) MEDIA SPEND MANAGEMENT USING REAL-TIME PREDICTIVE MODELING OF MEDIA SPEND EFFECTS ON INVENTORY PRICING

(71) Applicants: Anto Chittilappilly, Waltham, MA (US); Payman Sadegh, Alpharetta, GA (US)

(72) Inventors: Anto Chittilappilly, Waltham, MA (US); Payman Sadegh, Alpharetta, GA (US)

(21) Appl. No.: 15/491,903

(22) Filed: Apr. 19, 2017

Related U.S. Application Data
(60) Provisional application No. 62/324,799, filed on Apr. 19, 2016.

(51) Int. Cl. G06Q 10/08; G06N 5/04; G06N 99/00; G06Q 30/02

(52) U.S. Cl. CPC G06Q 10/087; G06Q 30/0277; G06N 5/04; G06N 99/005

(57) ABSTRACT

A method, system, and computer program product for media spend management. An Internet media planning and purchasing application executes on a management interface device. Servers execute operations to predict various inventory and pricing effects that result from a particular Internet media planning and purchasing plan. Machine learning techniques are used to form a stimulus attribution predictive model based on stimulus data records and respective response data records received over a network path. Additional predictive models are formed, including (1) an ad inventory predictive model derived from ad inventory data records and (2) an ad pricing predictive model derived from ad pricing data records. A set of media spend allocation parameters are received from the management interface, and those parameters are used to produce predicted inventory changes that in turn affect parameters in the ad pricing predictive model. Media spend allocation performance parameters are predicted based on the affected media prices.

### RELATED APPLICATIONS

The present application claims the benefit of priority to co-pending U.S. Provisional Patent Application Ser. No. 62/324,799, entitled “Improving Media Spend Management Using Real-time Predictive Modeling of Media Spend Effects on an Ad Inventory Pricing” (Attorney Docket No. VISQ.P0023P), filed Apr. 19, 2016, which is hereby expressly incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosure relates to the field of media spend management and more particularly to techniques for improving media spend management using real-time predictive modeling of media spend effects on inventory pricing.

### BACKGROUND

The prevalent and expanding technology network enabling today's digital advertising ecosystem offers advertisers numerous ad content choices for stimulating a target audience to invoke a certain response (e.g., a purchase or an action or a conversion). Along with the inexorable expansion of the breadth and depth of the Internet, an ecosystem of buyers and sellers of various forms of media has evolved. On the sell side are publishers (e.g., Yahoo!, ESPN, etc.) who use publishing assets to reach audiences of Internet content. In comparison to publishers for offline media channels (e.g., TV, print, etc.) who maintain certain ratios of advertising to programming content, publishers for online or digital media channels are challenged by uncertainty in their ad inventory and/or in selling out their ad inventory. Ad networks help mitigate such uncertainty by aggregating global ad inventory (e.g., impressions) collected from the Internet based on context, audience, and/or other characteristics to enable a more efficient market for media sellers (e.g., publishers) and media buyers (e.g., advertisers). In some cases, the market transactions are through digital media exchanges or ad exchanges. Demand-side platforms (DSPs) further leverage networking and computing technology to improve digital advertising market efficiencies by accessing ad inventory (e.g., through ad networks, ad exchanges, etc.) and placing the buys on behalf of the advertiser. Professional marketing managers for such advertisers are often tasked with navigating through this complex ecosystem to allocate millions of dollars of media spend among this massive set of advertising choices, so that the performance (e.g., return on investment or ROI) of the marketing campaign is aligned with the advertiser's objectives (e.g., product sales, brand recognition, etc.). This task might compel the marketing manager to want to be able to predict the performance of a media spend plan before deployment of such a plan.

A predictive model for estimating the performance of a media spend plan needs to account for many dynamic variables in relating the stimuli and responses associated with a marketing campaign. In some cases, the predictive model can use historical stimulus and response data to predict the response to various stimuli mix scenarios. Such scenarios can be related to media spend levels and certain performance metrics using historical ad pricing (e.g., cost per impression). In some cases, the marketing manager might allocate spending to a particular set of ad inventory and that spending might affect the pricing of the ad inventory. Unfortunately, legacy models are often too optimistic, at least in that legacy models fail to model dynamic pricing effects.

Techniques are needed address the problem of estimating the affect an advertiser's purchase of certain ad inventory has on the performance (e.g., ROI) of the ad inventory spend.

None of the aforementioned legacy approaches achieve the capabilities of the herein-disclosed techniques for improving media spend management using real-time predictive modeling of media spend effects on ad inventory pricing. Therefore, there is a need for improvements.

### BRIEF DESCRIPTION OF THE DRAWINGS

FIG. 1A depicts techniques for improving media spend management using real-time predictive modeling of media spend effects on inventory pricing, according to some embodiments.

FIG. 1B exemplifies an environment in which embodiments of the present disclosure can operate.

FIG. 2 presents a stimulus attribution predictive modeling technique used in systems for improving media spend management using real-time predictive modeling of media spend effects on inventory pricing, according to some embodiments.

FIG. 3A depicts a user interaction environment for selecting and viewing predicted performance results of a media spend scenario, according to some embodiments.

FIG. 3B shows a set of media spend scenario performance results plotted in an interactive interface, according to some embodiments.

FIG. 4 depicts an environment in which embodiments of the present disclosure can operate.

FIG. 5A illustrates fixed inventory ad pricing curves.

FIG. 5B illustrates inventory-dependent ad pricing curves.

FIG. 6 presents an ad inventory predictive modeling technique used in systems improving media spend management using real-time predictive modeling of media spend effects on ad inventory pricing, according to some embodiments.

FIG. 7 presents an ad pricing predictive modeling technique used in systems improving media spend management using real-time predictive modeling of media spend effects on ad inventory pricing, according to some embodiments.

FIG. 8A depicts a user interaction environment for selecting and viewing predicted performance results of a media spend plan as displayed in a user interface to systems for improving media spend management using real-time predictive modeling of media spend effects on ad inventory pricing, according to some embodiments.

FIG. 8B shows media spend performance results plotted in an interactive interface as implemented in systems for improving media spend management using real-time predictive modeling of media spend effects on ad inventory pricing, according to some embodiments.

FIG. 9A depicts a subsystem for improving media spend management using real-time predictive modeling of media spend effects on ad inventory pricing, according to some embodiments.

FIG. 9B is a flowchart used in systems for improving media spend management using real-time predictive modeling of media spend effects on ad inventory pricing, according to some embodiments.

FIG. 10 is a block diagram of a system for improving media spend management using real-time predictive modeling of media spend effects on ad inventory pricing, according to an embodiment.

FIG. 11A, and FIG. 11B depict block diagrams of computer system components suitable for implementing embodiments of the present disclosure.

### DETAILED DESCRIPTION

### Overview

Disclosed herein are a media spend allocation planner and a series of predictive models that are used for estimating the performance of a media spend plan. The models account for many dynamic variables in relating the stimuli and responses associated with a marketing campaign. In some cases, the predictive model can use historical stimulus and response data to predict the response to various stimuli mix scenarios. Such scenarios can be related to media spend levels and certain performance metrics using historical ad pricing (e.g., cost per impression). In some cases, the marketing manager might allocate spending to a particular set of ad inventory, which in turn might affect the pricing of the ad inventory. The effect of spending (e.g., changes to inventory and pricing) are estimated so as to estimate the overall performance of a media spend plan even after considering the effect that the spending plan (e.g., depletion of inventory) might have on pricing of the media.

The herein-described scenario planner uses a closed loop feedback system for dynamically transmitting allocated inventory buy parameters characterizing one or more media buys from a media spend scenario to an ad inventory predictive model and an ad pricing predictive model to estimate in real time the effect of the media buys on the performance of the media spend scenario. The system updates in real time to show the estimated performance of the media spend scenario as being responsive to a change in pricing based in part on the ad inventory buys associated with the media spend allocations selected by the marketing manager. The media spend allocation options and the real-time media spend performance can be presented to the marketing manager by a media planning application, such that the marketing manager can select a media spend plan for deployment.

### Definitions

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances
The articles “a” and “an” as used in this application and the appended claims should generally be construed to mean “one or more” unless specified otherwise or is clear from the context to be directed to a singular form.

### Solutions Rooted in Technology

The appended figures corresponding to the discussions given herein provides sufficient disclosure to make and use systems, methods, and computer program products that address the aforementioned issues with legacy approaches. More specifically, the present disclosure provides a detailed description of techniques used in systems, methods, and in computer program products for improving media spend management using real-time predictive modeling of media spend effects on ad inventory pricing. Certain embodiments are directed to technological solutions for delivering allocated inventory buy parameters characterizing one or more media buys from a media spend scenario to an ad inventory predictive model and an ad pricing predictive model to estimate in real time the effects of the media buys on the performance of the media spend scenario. Such embodiments advance the relevant technical fields, as well as advancing peripheral technical fields.

In particular, the herein-disclosed techniques provide technical solutions that address the technical problems attendant to processing data transmitted over the Internet that is then used in estimating the effects that an advertiser's purchase might have on ad inventory and on performance (e.g., ROI) of the media spend. Some of the exemplary technical solutions rely on dynamically generated results from multiple machine learning models that are continually updated using large volumes of advertising data collected over the Internet. The dynamically generated results from multiple machine learning models are used to deliver real-time responses to graphical user interfaces. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of machine-to-machine computing as well as advances in various technical fields related to machine learning models and their applications.

Reference is now made in detail to certain embodiments. The disclosed embodiments are not intended to be limiting of the claims.

### Descriptions of Exemplary Embodiments

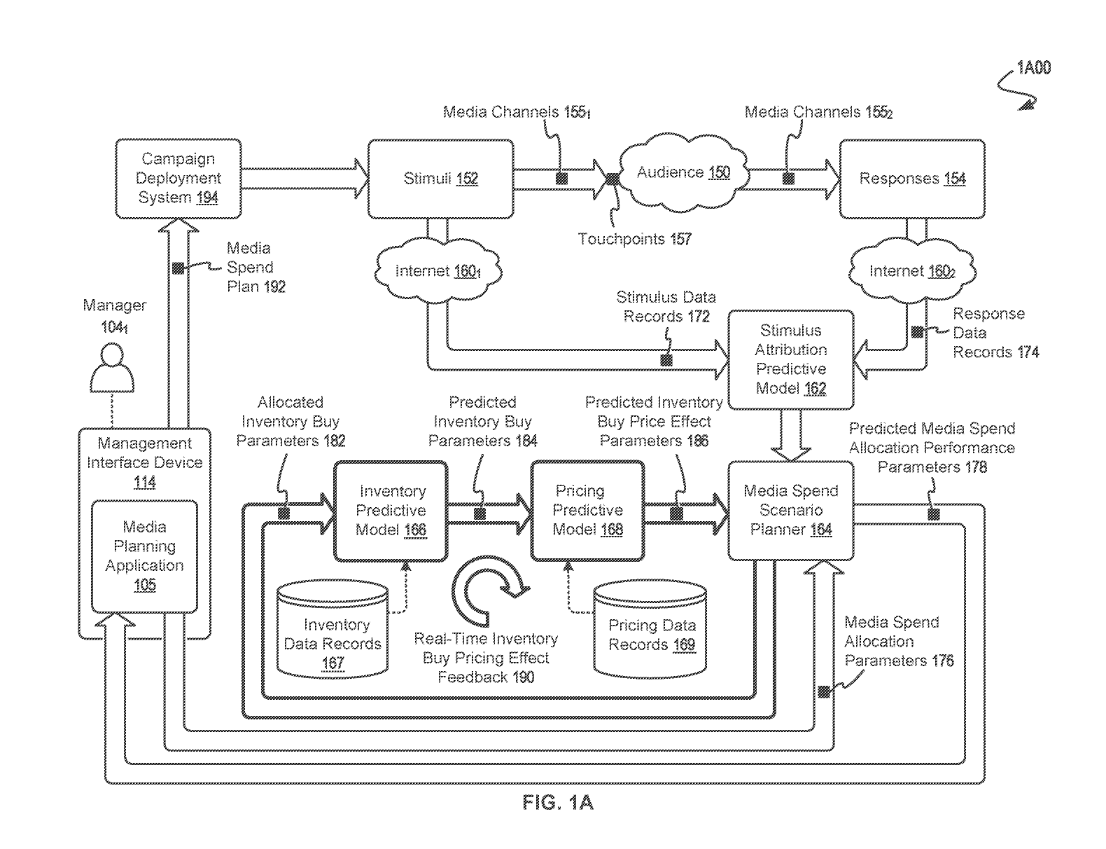

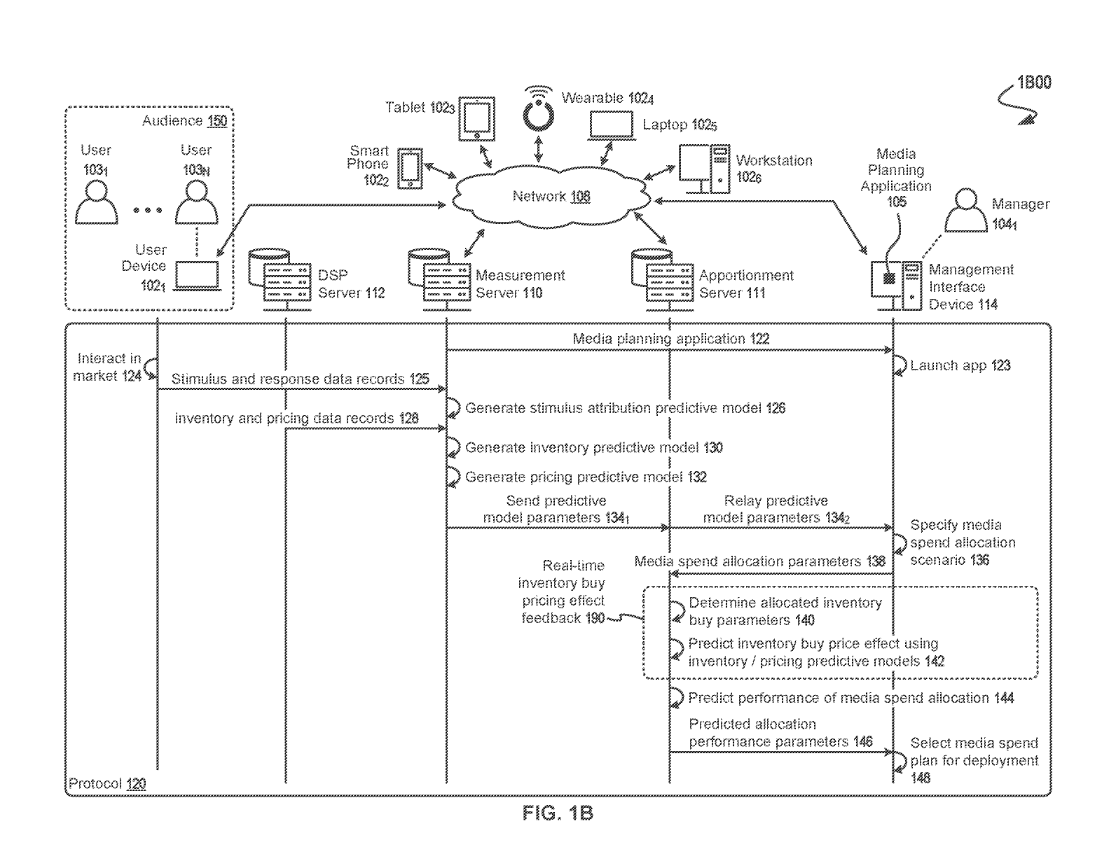

FIG. 1A depicts techniques 1A00 for improving media spend management using real-time predictive modeling of media spend effects on inventory pricing. As an option, one or more instances of techniques 1A00 or any aspect thereof may be implemented in the context of the architecture and functionality of the embodiments described herein. Also, the techniques 1A00 or any aspect thereof may be implemented in any desired environment.

As shown in FIG. 1A, a set of stimuli 152 is presented to an audience 150 (e.g., as part of a message campaign), that further produces a set of responses 154. For example, the stimuli 152 might be part of a message campaign developed by a campaign manager (e.g., manager 104₁) to reach the audience 150 with the objective to generate user responses (e.g., sales of a certain product, compliance to a request, etc.). The stimuli 152 is delivered to the audience 150 through certain instances of media channels 155₁ that can comprise digital or online media channels (e.g., online display, online search, paid social media, email, etc.). The media channels 155₁ can further comprise non-digital or offline media channels (e.g., TV, radio, print, etc.). The audience 150 is exposed to each stimulation comprising the stimuli 152 through a set of touchpoints 157 characterized by certain respective attributes. The responses 154 can also be delivered through other instances of media channels 155₂ that can further comprise online and offline media channels. In some cases, the information indicating a particular response can be included in the attribute data associated with the instance of the touchpoints 157 to which the user is responding. The portion of stimuli 152 delivered through online media channels can be received by the users comprising an audience 150 at various instances of user devices (e.g., mobile phone, laptop computer, desktop computer, tablet, etc.). Further, the portion of responses 154 received through digital media channels can also be invoked by the users comprising audience 150 using the user devices.

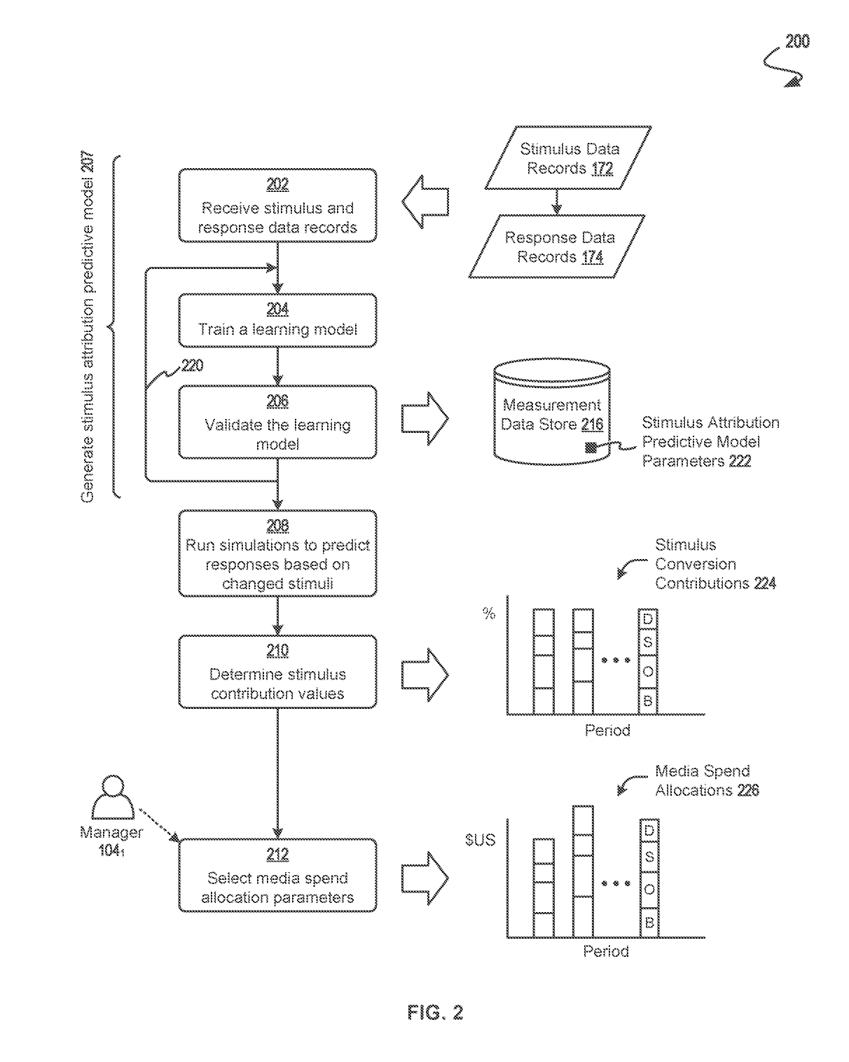

As further shown, a set of stimulus data records 172 and a set of response data records 174 can be received over a network (e.g., Internet 160₁ and Internet 160₂, respectively) to be used to generate a stimulus attribution predictive model 162. The response data records 174 are derived from user interaction with a user device that is connected to the Internet. An attribution model (e.g., the shown stimulus attribution predictive model 162) can be used to estimate the effectiveness of each stimulus in a certain marketing campaign by attributing conversion credit (e.g., contribution value) to the various stimuli comprising the campaign. More specifically, stimulus attribution predictive model 162 can be used to estimate the temporal attribution (e.g., contribution value) of each stimulus and/or group of stimuli (e.g., a channel from the media channels 155₁) to the conversions comprising the response data records 174. The stimulus attribution predictive model 162 can be formnned using any machine learning techniques (e.g., see FIG. 2) to accurately model the relationship between the stimuli 152 and the responses 154. For example, weekly summaries of the stimulus data records 172 and the response data records 174 over a certain historical period (e.g., last six months) can be used to generate the stimulus attribution predictive model 162. When formed, the stimulus attribution predictive model 162 can be described in part by certain model parameters (e.g., input variables, output variables, equations, equation coefficients, mapping relationships, limits, constraints, etc.).

A media spend scenario planner 164 might be used in combination with the stimulus attribution predictive model 162 to enable the manager 104₁ to select a media spend allocation plan for a given campaign. For example, the manager 104₁ can access the media spend scenario planner 164 using a media planning application 105 operating on a management interface device 114 (e.g., laptop computer) to test various media spend allocation scenarios. For example, a media spend allocation scenario might allocate a media spend budget among a digital search channel, a digital display channel, a TV channel, and/or a radio channel. Higher and/or lower levels of allocation granularity are possible. For a given media spend allocation scenario characterized by a set of media spend allocation parameters 176, the media spend scenario planner 164 can generate a set of predicted media spend allocation performance parameters 178 corresponding to a predicted performance (e.g., compliance, conversions, ROI, other performance metrics, etc.) of the media spend allocation scenario to be used in presenting such a response and/or performance to the manager 104₁ in the media planning application 105. The manager 104₁ can compare various media spend allocation scenarios to select a media spend plan 192 for deployment to the audience 150 by a campaign deployment system 194.

In some cases, the manager 104₁ might want to know the effect the purchase of certain inventory associated with a given media spend allocation scenario has on the performance (e.g., ROI) of the inventory spend and/or the overall media spend allocation scenario. The herein disclosed techniques provide a technological solution for the manager 104₁ by implementing a real-time inventory buy pricing effect feedback 190. Specifically, in one or more embodiments, a set of allocated inventory buy parameters 182 (e.g., publisher sites, inventory buy periods, etc.) can be determined in part from the media spend allocation parameters 176 and applied to an inventory predictive model 166. In some embodiments, the inventory predictive model 166 can be formed in part using a set of inventory data records 167 (e.g., historical publisher available inventory or “avails”, etc.). By applying the allocated inventory buy parameters 182 to the inventory predictive model 166, a set of predicted inventory buy parameters 184 (e.g., publisher sites, inventory buy quantities, etc.) can be produced. In some embodiments, the predicted inventory buy parameters 184 can be applied to a pricing predictive model 168 formed, in part, by using a set of pricing data records 169 (e.g., historical ad cost per one thousand viewers or “CPM”, etc.). By applying the predicted inventory buy parameters 184 to the pricing predictive model 168, a set of predicted inventory buy price effect parameters 186 (e.g., adjusted price, etc.) can be produced. The predicted inventory buy price effect parameters 186 can be fed back into the media spend scenario planner 164 in real time to include any inventory buy price effects in the predicted media spend allocation performance parameters 178 delivered to the media planning application 105 for viewing by the manager 104₁. In such cases, the real-time inventory buy pricing effect feedback 190 enables any inventory buy price effects to be included the performance metrics of a given media spend scenario such that the manager 104₁ can make a better informed (e.g., more accurate) selection of the media spend plan 192.

The herein-disclosed technological solution described by the techniques 1A00 in FIG. 1A can be implemented in various network computing environments and associated online and offline marketplaces. Such an environment is discussed as pertains to FIG. 1B.

FIG. 1B exemplifies an environment 1B00 in which embodiments of the present disclosure can operate. As an option, one or more instances of environment 1B00 or any aspect thereof may be implemented in the context of the architecture and functionality of the embodiments described herein. Also, the environment 1B00 or any aspect thereof may be implemented in any desired environment.

As shown in FIG. 1B, the environment 1B00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 10B comprises at least one instance of a measurement server 110, at least one instance of an apportionment server 111, at least one instance of a demand-side platform server (e.g., DSP server 112), and at least one instance of a management interface device 114. The servers and devices shown in environment 1B00 can represent any single computing system with dedicated hardware and software, multiple computing systems clustered together (e.g., a server farm, a host farm, etc.), a portion of shared resources on one or more computing systems (e.g., a virtual server), and/or any combination thereof.

The environment 1B00 further comprises at least one instance of a user device 102₁ that can represent one of a variety of other computing devices (e.g., a smart phone 102₂, a tablet 102₁, a wearable computing device 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102₁ can be operated by a user 103_{N} Other users (e.g., user 103₁) with or without a corresponding user device can comprise the audience 150. Also, as earlier described in FIG. 1A, the media planning application 105 can be operating on the management interface device 114 and accessible by the manager 104₁.

As shown, the user 103₁, the user device 102₁ (e.g., operated by user 103_{N}), the measurement server 110, the apportionment server 111, the DSP server 112, and the management interface device 114 (e.g., operated by the manager 104₁) can exhibit a set of high-level interactions (e.g., operations, messages, etc.) in a protocol 120. Specifically, the protocol can represent interactions in systems for improving media spend management using real-time predictive modeling of media spend effects on inventory pricing. As shown, the manager 104₁ can download the media planning application 105 from the measurement server 110 to the management interface device 114 (see message 122) and launch the application (see operation 123). Users in audience 150 can also interact with various marketing campaign stimuli delivered through certain media channels (see operation 124), such as taking one or more measureable actions in response to such stimuli and/or other non-media effects. Information characterizing the stimuli and responses of the audience 150 can be collected as stimulus data records (e.g., stimulus data records 172) and response data records (e.g., response data records 174) by the measurement server 110 (see message 125). Using the stimulus and response data, the measurement server 110 can generate a stimulus attribute predictive model (see operation 126), such as stimulus attribution predictive model 162. The measurement server 110 can further collect inventory and pricing data records (see message 128) from various data sources in the ecosystem, such as the DSP server 112. The measurement server 110 can use such inventory and pricing data records to generate an inventory predictive model (see operation 130) such as inventory predictive model 166, and a pricing predictive model (see operation 132) such as pricing predictive model 168. The model parameters characterizing the aforementioned generated predictive models can be sent or otherwise availed to the apportionment server 111 (see message 134₁) and possibly relayed to a management interface device (see message 1342).

Further details regarding a general approaches to generating predictive models are described in U.S. application Ser. No. 14/145,625 (Attorney Docket ID: VISQ.P0004), titled “MEDIA SPEND OPTIMIZATION USING A CROSS-CHANNEL PREDICTIVE MODEL”, and U.S. application Ser. No. 13/492,493 entitled. “A METHOD AND SYSTEM FOR DETERMINING TOUCHPOINT ATTRIBUTION”, filed Jun. 8, 2012, now U.S. Pat. No. 9,183,562, the contents of both which are incorporated by reference in their entirety in this Application.

The manager 104₁ can further use the media planning application 105 on the management interface device 114 to specify a media spend allocation scenario (see operation 136). The media spend allocation scenario can be characterized by media spend allocation parameters that can be sent to the apportionment server 111 (see message 138) for simulation (e.g., by the media spend scenario planner 164). In some cases, the manager 104₁ might want to know the effect the purchase of certain inventory associated with the media spend allocation scenario has on the performance (e.g., ROI) of the inventory spend and/or the overall media spend allocation scenario. The herein disclosed techniques provide a technological solution by implementing the real-time inventory buy pricing effect feedback 190 in the shown subset of operations in the protocol 120. Specifically, the apportionment server 111 can determine a set of allocated inventory buy parameters from the media spend allocation parameters (see operation 140). The allocated inventory buy parameters can then be applied to the inventory predictive model and the pricing predictive model to predict any inventory buy price effects associated with the media spend allocation scenario (see operation 142). Such inventory buy price effects can then be used by the apportionment server 111 to predict the performance (e.g., conversions, ROI, etc.) of the media spend allocation scenario (see operation 144). A set of predicted allocation performance parameters associated with the media spend allocation scenario performance can be delivered to the management interface device 114 in real time (see message 146) to enable the manager 104₁ to select a media spend plan (e.g., media spend plan 192) for deployment (see operation 148).

As shown in FIG. 1B, the techniques disclosed herein address the problems attendant to estimating the effect the purchase of certain inventory associated with a media spend allocation scenario has on the performance (e.g., ROI) of the inventory spend and/or the overall media spend allocation scenario, in part, by applying the results from the real-time inventory buy pricing effect feedback 190 to a stimulus attribution predictive model (e.g., stimulus attribution predictive model 162). More details pertaining such stimulus attribution predictive models are discussed in the following and herein.

FIG. 2 presents a stimulus attribution predictive modeling technique 200 used in systems for improving media spend management using real-time predictive modeling of media spend effects on inventory pricing. As an option, one or more instances of stimulus attribution predictive modeling technique 200 or any aspect thereof may be implemented in the context of the architecture and functionality of the embodiments described herein. Also, the stimulus attribution predictive modeling technique 200 or any aspect thereof may be implemented in any desired environment.

FIG. 2 depicts process steps (e.g., stimulus attribution predictive modeling technique 200) used in the generation of a stimulus attribution predictive model (see grouping 207). As shown, stimulus data records 172 and response data records 174 associated with one or more historical marketing campaigns and/or time periods are received by a computing device and/or system (e.g., measurement server 110) over a network (see step 202). The information associated with the stimulus data records 172 and response data records 174 can be organized into various data structures. A portion of the collected stimulus and response data can be used to train a learning model (see step 204). A different portion of the collected stimulus and response data can be used to validate the learning model (see step 206). The processes of training and/or validating can be iterated (see path 220) until the learning model behaves within target tolerances (e.g., with respect to predictive statistical metrics, descriptive statistics, significance tests, etc.). In some cases, additional historical stimulus and response data can be collected to further train and/or validate the learning model. When the learning model has been generated, a set of stimulus attribution predictive model parameters 222 (e.g., input variables, output variables, equations, equation coefficients, mapping relationships, limits, constraints, etc.) describing the learning model (e.g., stimulus attribution predictive model 162) can be stored in a measurement data store 216 for access by various computing devices (e.g., measurement server 110, management interface device 114, apportionment server 111, etc.).

Specifically, the learning model (e.g., stimulus attribution predictive model 162) might be used to run simulations (e.g., at the apportionment server 111) to predict responses based on changed stimuli (see step 208) such that contribution values for each stimulus and/or group of stimuli can be determined (see step 210). For example, a sensitivity analysis can be performed using the stimulus attribution predictive model 162 to generate a chart showing the stimulus conversion contributions 224 over the studied historical periods. Specifically, a percentage contribution for the stimuli comprising a display (“D”) channel, a search (“S”) channel, an offline (“O”) channel (e.g., TV), and a base (“B”) channel (e.g., related to responses not statistically attributable to any stimuli, such as those related to brand equity) can be determined for each period (e.g., week). Further, a marketing manager (e.g., manager 104₁) can use the stimulus conversion contributions 224 to further allocate spend among the various media stimuli (e.g., channels “D”, “S”, and “O”) by selecting associated stimulus spend allocation parameters (see step 212). For example, the manager 104₁ might apply an overall periodic marketing budget (e.g., in $US) to the various channels according to the relative stimulus contributions presented in the stimulus conversion contributions 224 to produce certain instances of stimulus spend allocations 226 (e.g., SUS per channel) for each analyzed period. In some cases, the stimulus spend allocations 226 can be automatically generated (e.g., recommended) based on the stimulus conversion contributions 224.

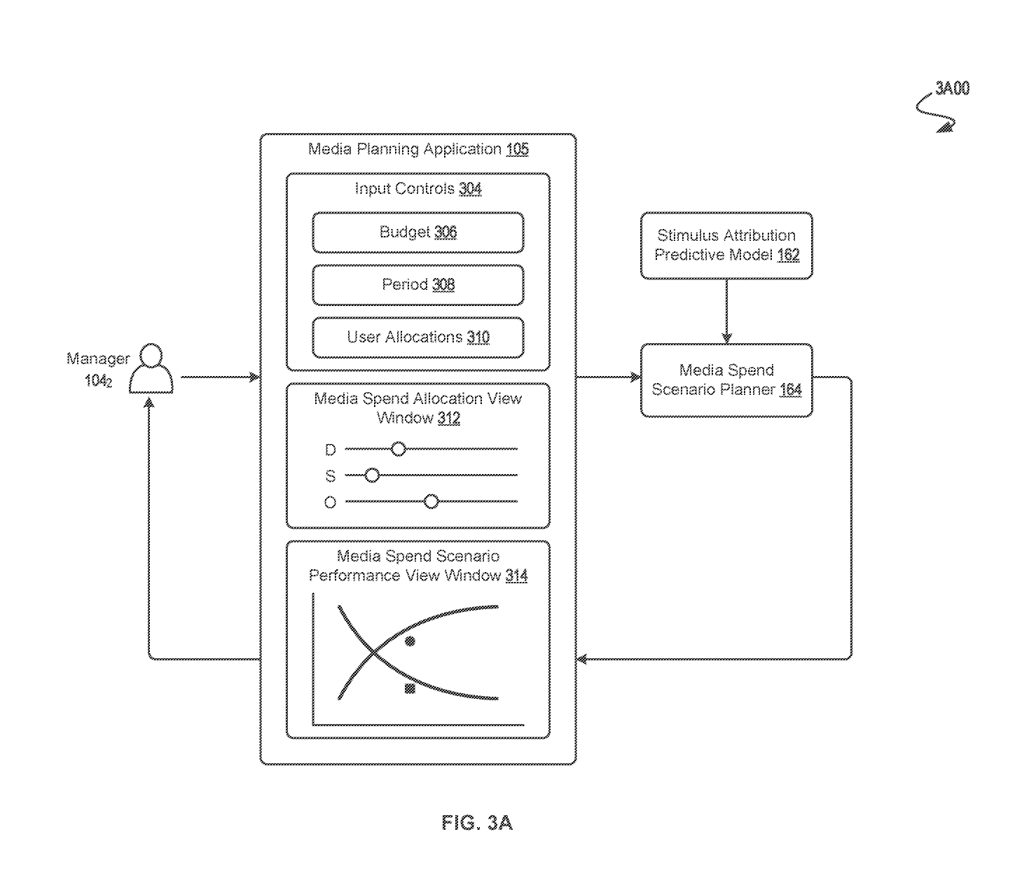

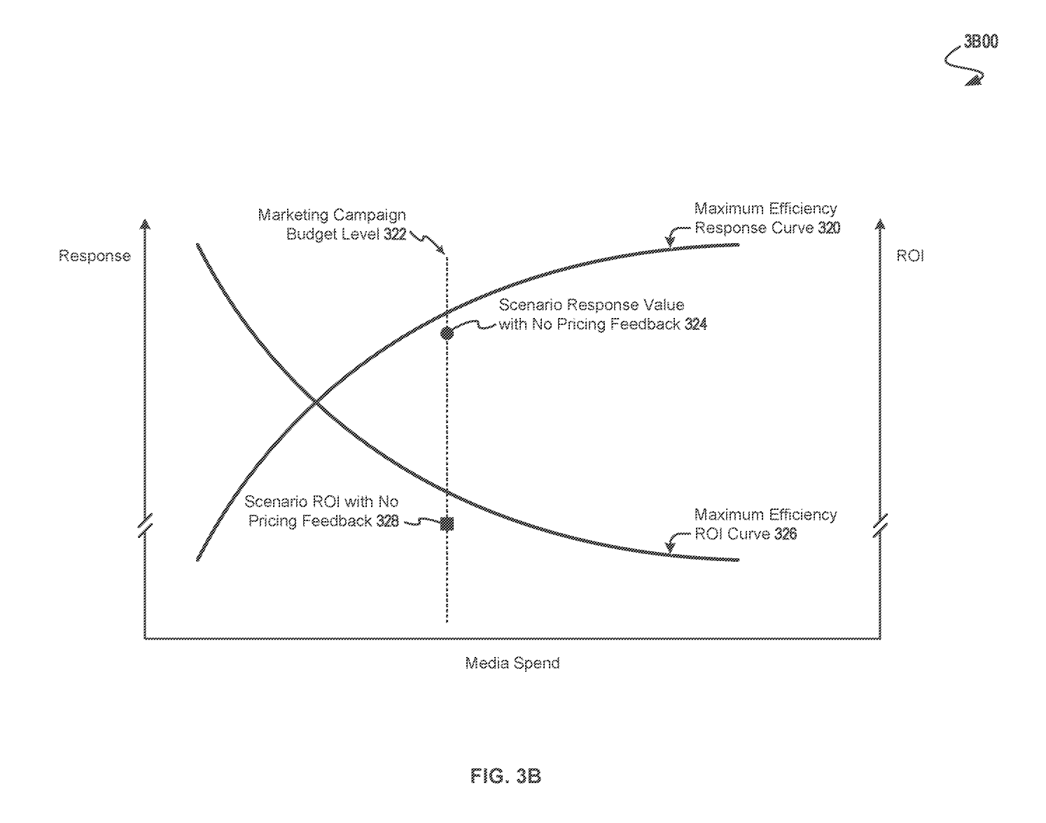

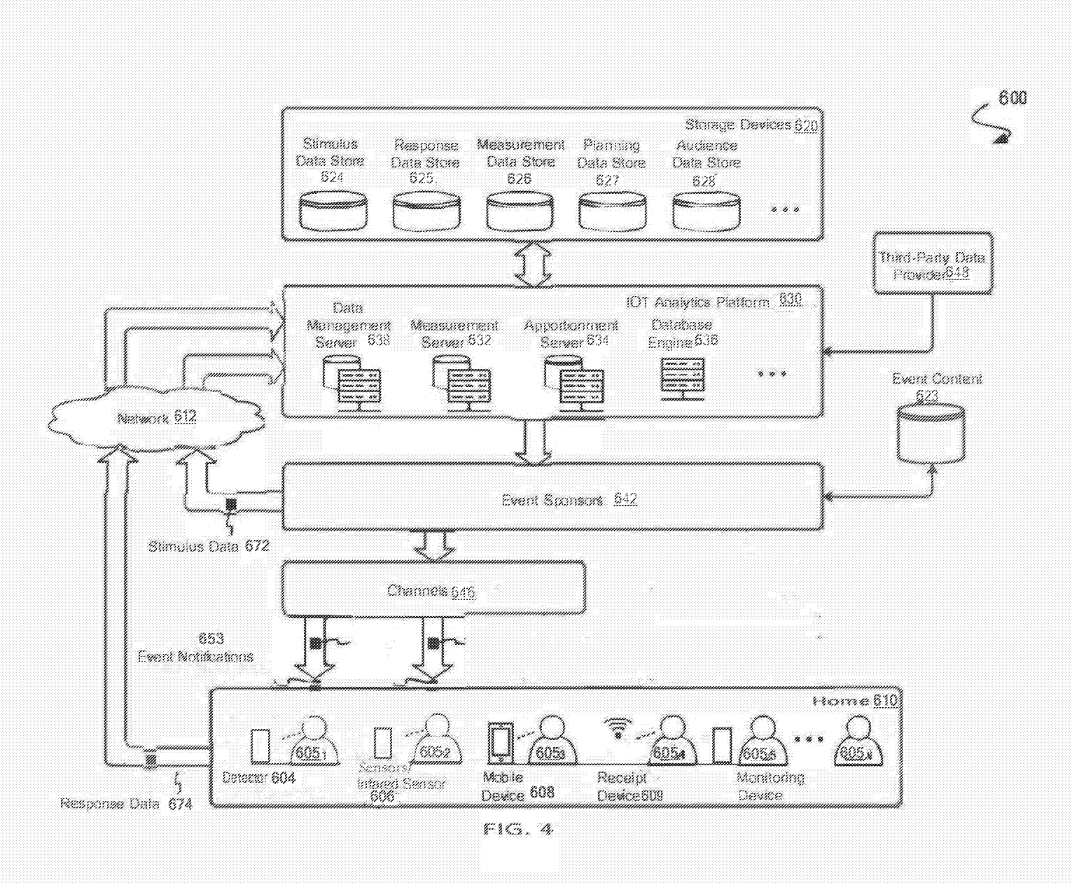

A stimulus attribution predictive model formed according to the stimulus attribution predictive modeling technique 200 can be used with the media spend scenario planner 164 and the media planning application 105 to enable a user to simulate various media spend allocation scenarios. Such an implementation is described as pertains to FIG. 3A.

FIG. 3A depicts a user interaction environment 3A00 for selecting and viewing predicted performance results of a media spend scenario. As an option, one or more instances of user interaction environment 3A00 or any aspect thereof may be implemented in the context of the architecture and functionality of the embodiments described herein. Also, the user interaction environment 3A00 or any aspect thereof may be implemented in any desired environment.

The user interaction environment 3A00 comprises the stimulus attribution predictive model 162, the media spend scenario planner 164, and the media planning application 105 described in FIG. 1A and herein. As shown, a user (e.g., manager 104₂) can interact with the media planning application 105 to configure and/or invoke certain operations at the media spend scenario planner 164 to predict the performance of various media spend allocation scenarios. Specifically, the manager 104₂ interacts with the media planning application 105 using various display components (e.g., text boxes, sliders, pull-down menus, widgets, view windows, etc.) that serve to capture various user inputs and/or render various information for user viewing. More specifically, the manager 104₂ can input certain information using a set of input controls 304. For example, the input controls 304 can include presentation and capturing aspects of a budget 306 (e.g., a selected currency, a budget level, etc.), a period 308 (e.g., days, weeks, months, quarters, etc.), and/or user allocations 310 (e.g., selected spend allocations). Other control components are possible. Further, the manager 104₂ can view and/or interact with a media spend allocation view window 312 and a media spend scenario performance view window 314. For example, the manager 104₂ might allocate spending in a given channel using the instances of the input controls 304 associated with the user allocations 310 and/or using the sliders associated available in the media spend allocation view window 312. Other view components are possible. In exemplary cases, the media spend scenario performance view window 314 might present various media spend allocation scenario performance results as discussed in FIG. 3B.

FIG. 3B shows a set of media spend scenario performance results 3B00 plotted in an interactive interface. As an option, one or more instances of media spend scenario performance results 3B00 or any aspect thereof may be implemented in the context of the architecture and functionality of the embodiments described herein. Also, the media spend scenario performance results 3B00 or any aspect thereof may be implemented in any desired environment.

As shown, the media spend scenario performance results 3B00 can comprise one or more instances of a maximum efficiency response curve 320 and/or one or more instances of a maximum efficiency ROI curve 326. The maximum efficiency response curve 320 and the maximum efficiency ROI curve 326 can be plotted on an XY plot with a common X-axis scale (e.g., “Media Spend”) and multiple Y-axis scales (e.g., “Response”, “ROI”). In one or more embodiments, the maximum efficiency response curve 320 can represent a range of maximum response values (e.g., number of conversions) a marketing campaign might produce for a given level of media spend, at least as predicted by a media spend scenario planner. For example, the media spend scenario planner 164 can use the stimulus attribution predictive model 162 and/or other information (e.g., ad pricing) to determine (e.g., using sensitivity analyses, simulation, etc.) the response value corresponding to the most efficient media channel spend allocation mix for a given level of media spend. Further, the maximum efficiency ROI curve 326 can represent a range of maximum ROI values (e.g., response revenue divided by ad cost) a marketing campaign might produce for a given level of media spend, at least as predicted by a media spend scenario planner. For example, the media spend scenario planner 164 can use the stimulus attribution predictive model 162 and/or other information (e.g., ad pricing, response revenue, etc.) to determine (e.g., using sensitivity analyses, simulation, etc.) the ROI corresponding to the most efficient media channel spend allocation mix for a given level of media spend.

The maximum efficiency response curve 320 and the maximum efficiency ROI curve 326 can be used by the marketing manager to visually assess the performance of a certain media spend allocation scenario. Specifically, as shown, the marketing manager might be asked to keep the overall media spend at or below a marketing campaign budget level 322. In such a case, the response value and ROI of a media spend allocation scenario predicted by the media spend scenario planner will lie on the level of media spend associated with the marketing campaign budget level 322 (see vertical dotted line). For example, with no implementation of the real-time inventory buy pricing effect feedback 190 according to the herein disclosed techniques, a certain media spend allocation scenario might result in a scenario response value with no pricing feedback 324, and/or a scenario ROI with no pricing feedback 328. For some marketing campaign channels and corresponding allocation mixes, such predicted performance results can be used by the marketing manager to determine a media spend plan. In other cases, the predicted performance results need to account for the media spend effects on inventory pricing using the herein disclosed techniques such that more accurate performance results are availed to the marketing manager for media spend planning. Various pricing curves representing a range of media channels that can require the implementation of the herein disclosed techniques are discussed in the following.

FIG. 4 depicts an environment 600 in which embodiments of the present disclosure can operate. As an option, one or more instances of environment 600 or any aspect thereof may be implemented in the context of the architecture and functionality of the embodiments described herein. Also, the environment 600 or any aspect thereof may be implemented in any desired environment.

The present invention has application for systems that utilize the Internet of Things (IOT). For these embodiments, systems communicate to environments, such as a home environment, to employ event campaigns that use stimuli to effectuate desired user responses. Specifically, devices may be placed in the home to both communicate event messages or notifications as well as receive responses, either responses gathered by sensing users or by direct input to electronic devices by the users. Embodiments for implementing the present invention in such an environment are shown in FIG. 4.

The shown environment 600 depicts a set of users (e.g., user 605¹, user 605₂, user 605₃, user 605₄, user 605₅, to user 605_{N}) comprising an audience 610 that might be targeted by one or more event sponsors 642 in various event campaigns. The users may view a plurality of event notifications (messages) 653 on a reception device 609 (e.g., desktop PC, laptop PC, mobile device, wearable, television, radio, etc.). The event notifications 653 can be provided by the event sponsors 642 through any of a plurality of channels 746 in the wired environment (e.g., desktop PC, laptop PC, mobile device, wearable, television, radio, print, etc.). Stimuli from the channels 646 comprise instances of touchpoint encounters 660 experienced by the users. As an example, a TV spot may be viewed on a certain TV station (e.g., touchpoint T1), and/or a print message (e.g., touchpoint T2) in a magazine. Further, the stimuli channels 746 might present to the users a banner ad on a mobile browser (e.g., touchpoint T3), a sponsored website (e.g., touchpoint T4), and/or an event notification in an email message (e.g., touchpoint T5). The touchpoint encounters 660 can be described by various touchpoint attributes, such as data, time, campaign, event, geography, demographics, impressions, cost, and/or other attributes.

According to one implementation, an IOT analytics platform 630 can receive instances of stimulus data 672 (e.g., stimulus touchpoint attributes, etc.) and instances of response data 674 (e.g., response measurement attributes, etc.) via network 612, describing, in part, the measured responses of the users to the delivered stimulus (e.g., touchpoints 660). The measure responses are derived from certain user interactions as sensed in the home (e.g., detector 604, sensor/infrared sensor 606, or monitoring device 611) or transmitted by the user (e.g., mobile device 611, etc.) performed by certain users and can be described by various response attributes, such as data, time, response channel, event, geography, revenue, lifetime value, and other attributes. A third-party data provider 648 can further provide data (e.g., user behaviors, user demographics, cross-device mapping, etc.) to the IOT analytics platform 630. The collected data and any associated generated data can be stored in one or more storage devices 620 (e.g., stimulus data store 624, response data store 625, measurement data store 626, planning data store 627, audience data store 628, etc.), which are made accessible by a database engine 636 (e.g., query engine, result processing engine, etc.) to a measurement server 632 and an apportionment server 634. Operations performed by the measurement server 632 and the apportionment server 634 can vary widely by embodiment. As an example, the measurement server 632 can be used to analyze certain data records stored in the stimulus data store 624 and response data store 625 to determine various performance metrics associated with an event campaign, storing such performance metrics and related data in measurement data store 626. Further, for example, the apportionment server 634 may be used to generate event campaign plans and associated event spend apportionment, storing such information in the planning data store 627.

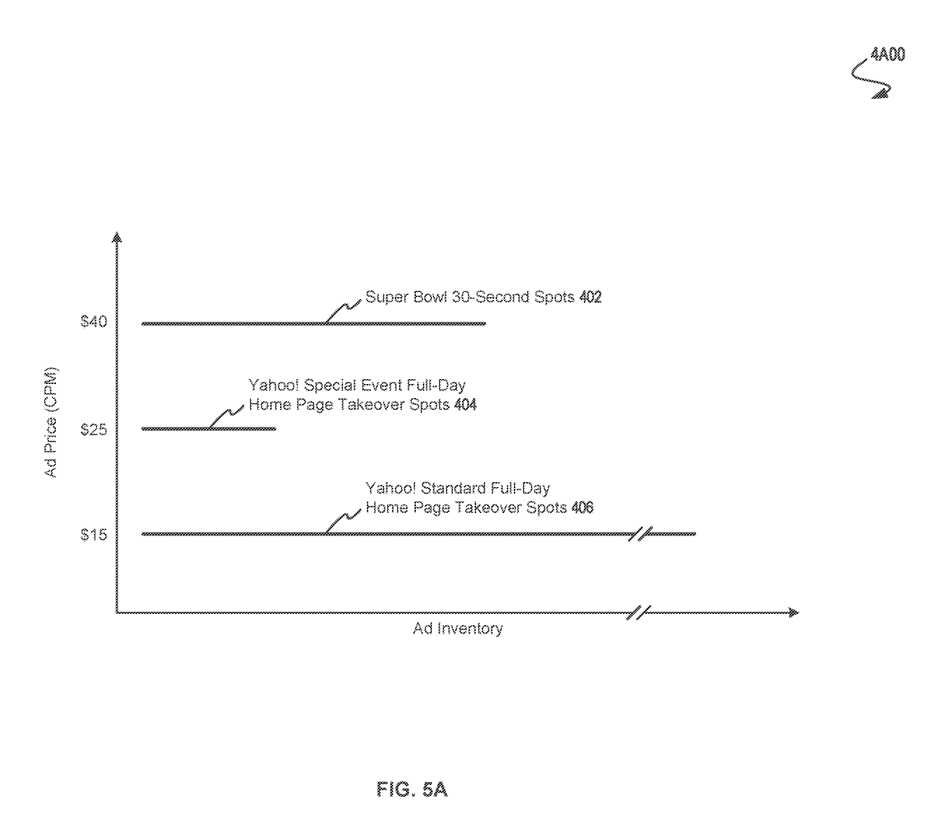

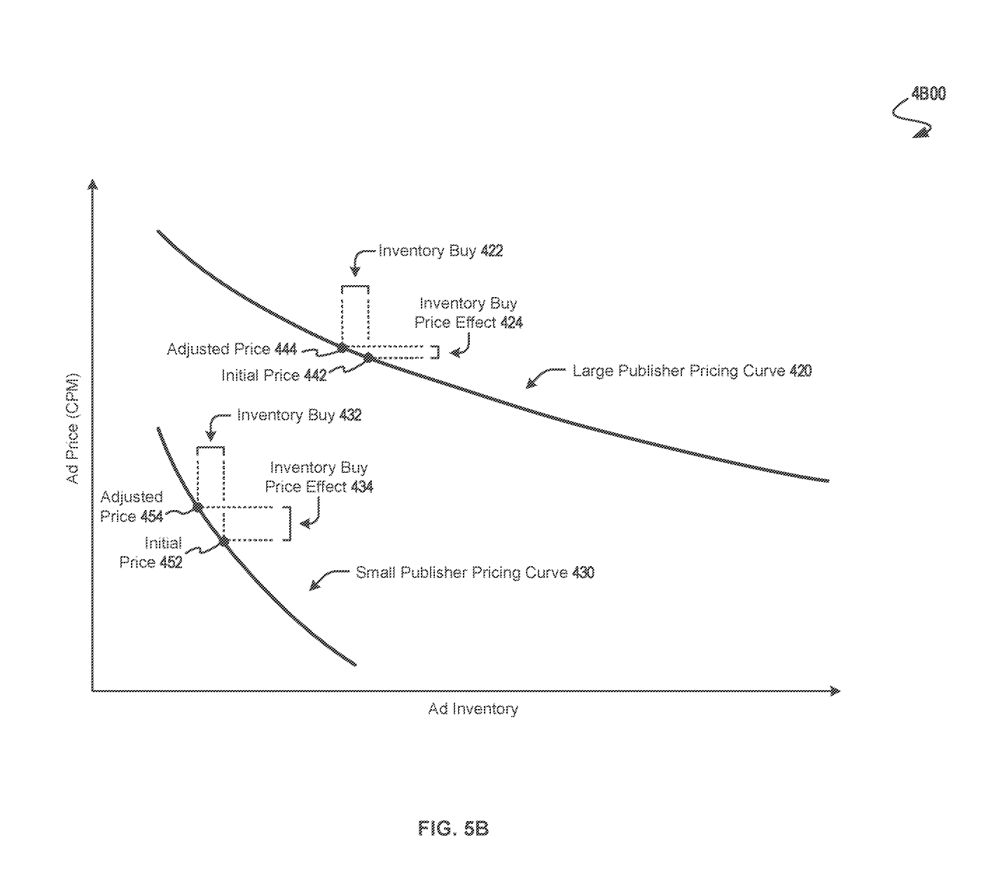

FIG. 5A illustrates fixed inventory ad pricing curves 4A00. As an option, one or more instances of fixed inventory ad pricing curves 4A00 or any aspect thereof may be implemented in the context of the architecture and functionality of the embodiments described herein. Also, the fixed inventory ad pricing curves 4A00 or any aspect thereof may be implemented in any desired environment.

The fixed inventory ad pricing curves 4A00 are merely examples of the relationship between ad price (e.g., CPM) and ad inventory when the ad inventory is a measurable constant value (e.g., “fixed”). For example, the curve representing the inventory of Super Bowl 30-second spots 402 might comprise a total of 60 spots each at an approximate CPM of $40 (e.g., $4.0 million per spot with 100 million viewers). The small and limited inventory of 60 units, and the known and desirable audience demographics, allow the publisher (e.g., a TV broadcasting network) to establish a premium price and pre-sell the ad inventory. As another example, the curve representing the inventory of Yahoo! standard full-day home page takeover spots 406 might comprise a total of 345 spots (e.g., for each of 345 days), each at an approximate CPM of $15 (e.g., $450,000 per spot with 30 million page views). While there can be uncertainty in the number of Yahoo! home page views on a given day, the recorded view history and limited spot inventory allow the publisher (e.g., Yahoo!) to sell such inventory at a fixed price. As shown, another curve representing the inventory of Yahoo! special event full-day home page takeover spots 404 can correspond to the pricing (e.g., CPM of $25) of ad spots on the Yahoo! home page on 20 special days (e.g., Cyber Monday, Super Bowl Sunday, etc.) throughout the year. The examples shown in fixed inventory ad pricing curves 4A00 represent advertising inventory having ad pricing that is unaffected by an ad inventory buy. FIG. 4B shows other ad pricing behavior examples that illustrate how ad inventory buys can affect ad pricing.

FIG. 5B illustrates inventory-dependent ad pricing curves 4B00. As an option, one or more instances of inventory-dependent ad pricing curves 4B00 or any aspect thereof may be implemented in the context of the architecture and functionality of the embodiments described herein. Also, the inventory-dependent ad pricing curves 4B00 or any aspect thereof may be implemented in any desired environment.

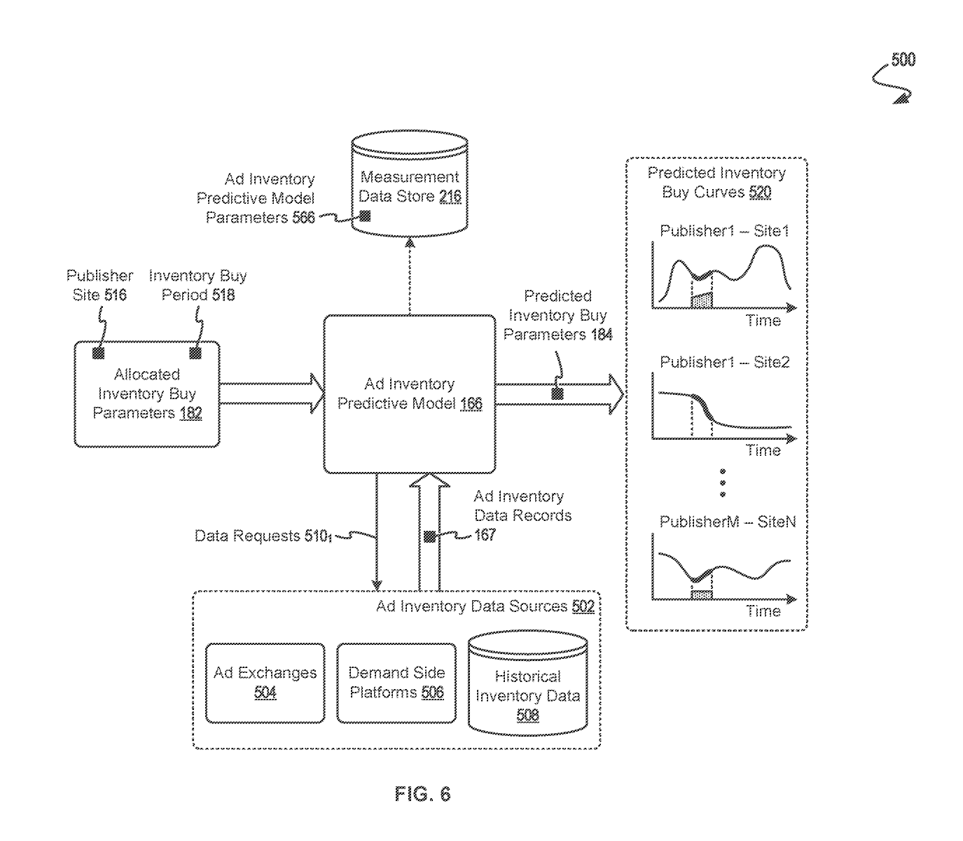

The inventory-dependent ad pricing curves 4B00 are merely examples of the relationship between ad price (e.g., CPM) and ad inventory when the ad pricing changes with the ad inventory. For example, a large publisher pricing curve 420 might represent the pricing of an inventory of 1,000,000 impressions availed by a large publisher (e.g., WSJ.com, ESPN.com, etc.). When an advertiser executes an inventory buy 422, there can be an inventory buy price effect 424 that increases the ad price from an initial price 442 to an adjusted price 444 as the inventory is reduced. Further, a small publisher pricing curve 430 might represent the pricing of an inventory of 300,000 impressions availed by a small publisher (e.g., SPIKE.com, etc.). When an advertiser executes an inventory buy 432, there can be an inventory buy price effect 434 that increases the ad price from an initial price 452 to an adjusted price 454 as the inventory is reduced. As shown, the inventory buy price effect 434 at the small publisher can be larger than the inventory buy price effect 424 at the large publisher for comparable inventory buys (e.g., inventory buy 432 and inventory buy 422). In both cases, the inventory buy price effect 424 and the inventory buy price effect 434 can impact the performance results of a media spend scenario planner, at least inasmuch as the ad price is used to determine various performance metrics (e.g., ROI). In such cases, the herein disclosed techniques can be used to estimate the effect the purchase of certain ad inventory associated with a media spend allocation scenario has on the performance (e.g., ROI) of the ad inventory spend and/or the overall media spend allocation scenario. In one or more embodiments, such techniques can implement an ad inventory predictive model as discussed in FIG. 6.

FIG. 6 presents an ad inventory predictive modeling technique 500 used in systems improving media spend management using real-time predictive modeling of media spend effects on ad inventory pricing. As an option, one or more instances of ad inventory predictive modeling technique 500 or any aspect thereof may be implemented in the context of the architecture and functionality of the embodiments described herein. Also, the ad inventory predictive modeling technique 500 or any aspect thereof may be implemented in any desired environment.

In the embodiment shown in FIG. 6, the ad inventory predictive model 166 can be formed from the ad inventory data records 167 and/or other information received by a computing device and/or system (e.g., measurement server 110) over a network. The information associated with the ad inventory data records 167 can be organized into various data structures. Further, the ad inventory data records 167 can be received from certain instances of ad inventory data sources 502 such as ad exchanges 504, demand side platforms 506, sets of historical inventory data 508, and/or other inventory data sources. The ad inventory data sources 502 can be polled continuously and/or at various times using instances of data requests 510₁ (e.g., HTTP requests) to collect the most relevant (e.g., most recent) set of ad inventory data records 167 for use in generating the ad inventory predictive model 166.

Specifically, a portion of the ad inventory data records 167 can be used to train the ad inventory predictive model 166. Further, a different portion of the ad inventory data records 167 can be used to validate the ad inventory predictive model 166. The processes of training and/or validating can be iterated until the ad inventory predictive model 166 behaves within target tolerances (e.g., with respect to predictive statistical metrics, descriptive statistics, significance tests, etc.). In some cases, additional instances of the ad inventory data records 167 can be collected (e.g., responsive to data requests 510₁) to further train and/or validate the ad inventory predictive model 166. When the ad inventory predictive model 166 has been generated, a set of ad inventory predictive model parameters 566 (e.g., input variables, output variables, equations, equation coefficients, mapping relationships, limits, constraints, etc.) describing the ad inventory predictive model 166 can be stored in the measurement data store 216 for access by various computing devices (e.g., measurement server 110, management interface device 114, apportionment server 111, etc.).

Specifically, in one or more embodiments, the real-time inventory buy pricing effect feedback 190 implemented in the herein disclosed techniques might apply to one or more instances of the allocated inventory buy parameters 182 as inputs to the ad inventory predictive model 166. Such allocated inventory buy parameters 182 might comprise one or more data records (e.g., key-value pairs) corresponding to a publisher site 516, an inventory buy period 518, and/or other attributes that have been entered or accepted using the management interface. The ad inventory predictive model 166 can use such inputs to produce a corresponding instance of the predicted inventory buy parameters 184. For example, as shown in the predicted inventory buy curves 520, the predicted inventory buy parameters 184 might comprise data characterizing curves representing available ad inventory levels over time for certain publisher sites (e.g., Publisher1-Site1, Publisher1-Site2, . . . , PublisherM-SiteN). The predicted inventory buy parameters 184 might further comprise data characterizing the portion of the available ad inventory levels specified for purchase according to the media spend allocation scenario represented in part by the allocated inventory buy parameters 182. Specifically, the shaded areas under the curves can represent the ad inventory buy quantity at each publisher site (e.g., instances of publisher site 516) for the shown inventory buy period (e.g., inventory buy period 518). For example, the predicted inventory buy curves 520 reflect an increasing ad inventory buy at Publisher1-Site1, no ad inventory buy at Publisher1-Site2, and a flat ad inventory buy at PublisherM-SiteN.

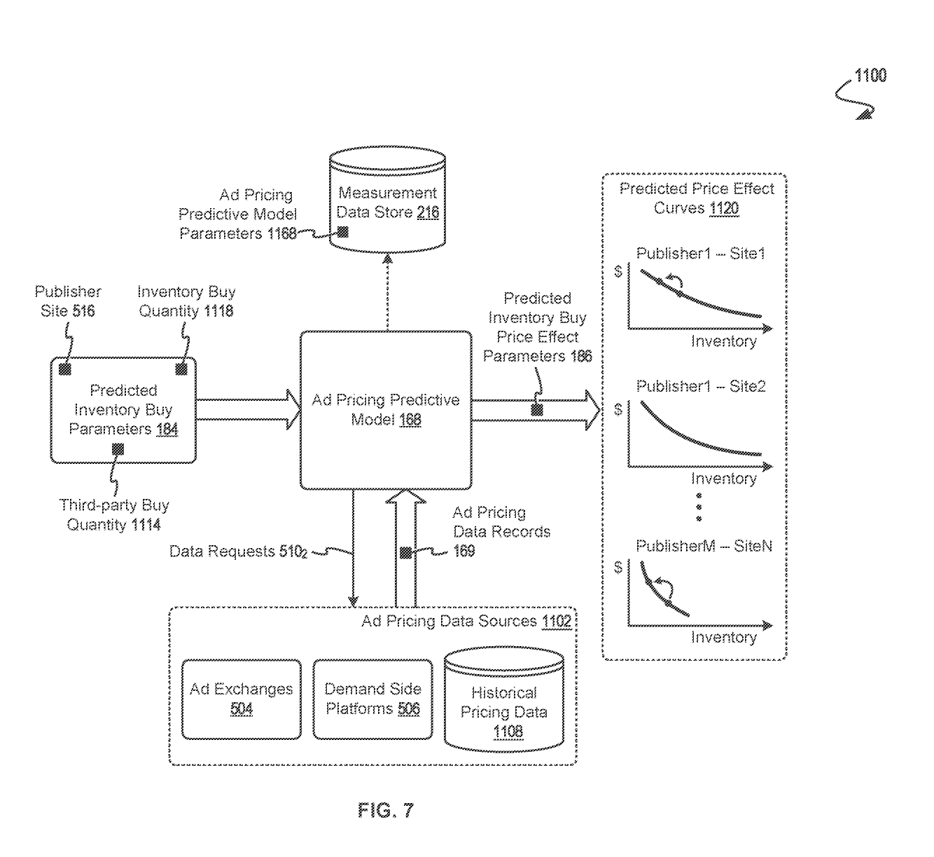

In one or more embodiments, the herein disclosed techniques can further implement an ad pricing predictive model as discussed in FIG. 7.

FIG. 7 presents an ad pricing predictive modeling technique 1100 used in systems improving media spend management using real-time predictive modeling of media spend effects on ad inventory pricing. As an option, one or more instances of ad pricing predictive modeling technique 1100 or any aspect thereof may be implemented in the context of the architecture and functionality of the embodiments described herein. Also, the ad pricing predictive modeling technique 1100 or any aspect thereof may be implemented in any desired environment.

In the embodiment shown in FIG. 7, the ad pricing predictive model 168 can be formed from the ad pricing data records 169 and/or other information received by a computing device and/or system (e.g., measurement server 110) over a network. The information associated with the ad pricing data records 169 can be organized into various data structures. Further, the ad pricing data records 169 can be received from certain instances of ad pricing data sources 1102 such as ad exchanges 504, demand side platforms 506, sets of historical pricing data 1108, and/or other pricing data sources. The ad pricing data sources 1102 can be polled continuously and/or at various times using instances of data requests 510₂ (e.g., HTTP requests) to collect the most relevant (e.g., most recent) set of ad pricing data records 169 for use in generating the ad pricing predictive model 168.

Specifically, a portion of the ad pricing data records 169 can be used to train the ad pricing predictive model 168. Further, a different portion of the ad pricing data records 169 can be used to validate the ad pricing predictive model 168. The processes of training and/or validating can be iterated until the ad pricing predictive model 168 behaves within target tolerances (e.g., with respect to predictive statistical metrics, descriptive statistics, significance tests, etc.). In some cases, additional instances of the ad pricing data records 169 can be collected (e.g., responsive to data requests 510₂) to further train and/or validate the ad pricing predictive model 168. When the ad pricing predictive model 168 has been generated, a set of ad pricing predictive model parameters 1168 (e.g., input variables, output variables, equations, equation coefficients, mapping relationships, limits, constraints, etc.) describing the ad pricing predictive model 168 can be stored in the measurement data store 216 for access by various computing devices (e.g., measurement server 110, management interface device 114, apportionment server 111, etc.).

Specifically, in one or more embodiments, the real-time inventory buy pricing effect feedback 190 implemented in the herein disclosed techniques might apply to one or more instances of the predicted inventory buy parameters 184 as inputs to the ad pricing predictive model 168. Such predicted inventory buy parameters 184 might comprise one or more data records (e.g., key-value pairs) corresponding to a publisher site 516, an inventory buy quantity 1118, and/or other attributes. Specifically, an estimate of a third-party buy quantity 1114 (e.g., purchased by other advertisers) might be included in the predicted inventory buy parameters 184. For example, the ad inventory predictive model 166 might estimate the third-party buy quantity 1114 based on historical trends, seasonality, buy patterns, and/or other attributes. The ad pricing predictive model 168 can use such inputs to produce a corresponding instance of the predicted inventory buy price effect parameters 186. For example, as shown in the predicted price effect curves 1120, the predicted inventory buy price effect parameters 186 might comprise data characterizing curves representing the relationship between ad pricing and available ad inventory levels for certain publisher sites (e.g., Publisher1-Site1. Publisher1-Site2, . . . , PublisherM-SiteN). The predicted inventory buy price effect parameters 186 might further comprise data characterizing the shift in ad pricing responsive to an inventory buy at each publisher site represented in part by the predicted inventory buy parameters 184. Specifically, the illustrated movement along the curves can represent the ad price shift corresponding to an ad inventory buy (e.g., instances of inventory buy quantity 1118) at each publisher site (e.g., instances of publisher site 516). For example, the predicted price effect curves 1120 reflect an increase in ad price at Publisher1-Site1, no ad price effect (e.g., due to no ad inventory buy) at Publisher1-Site2, and an ad price increase at PublisherM-SiteN.

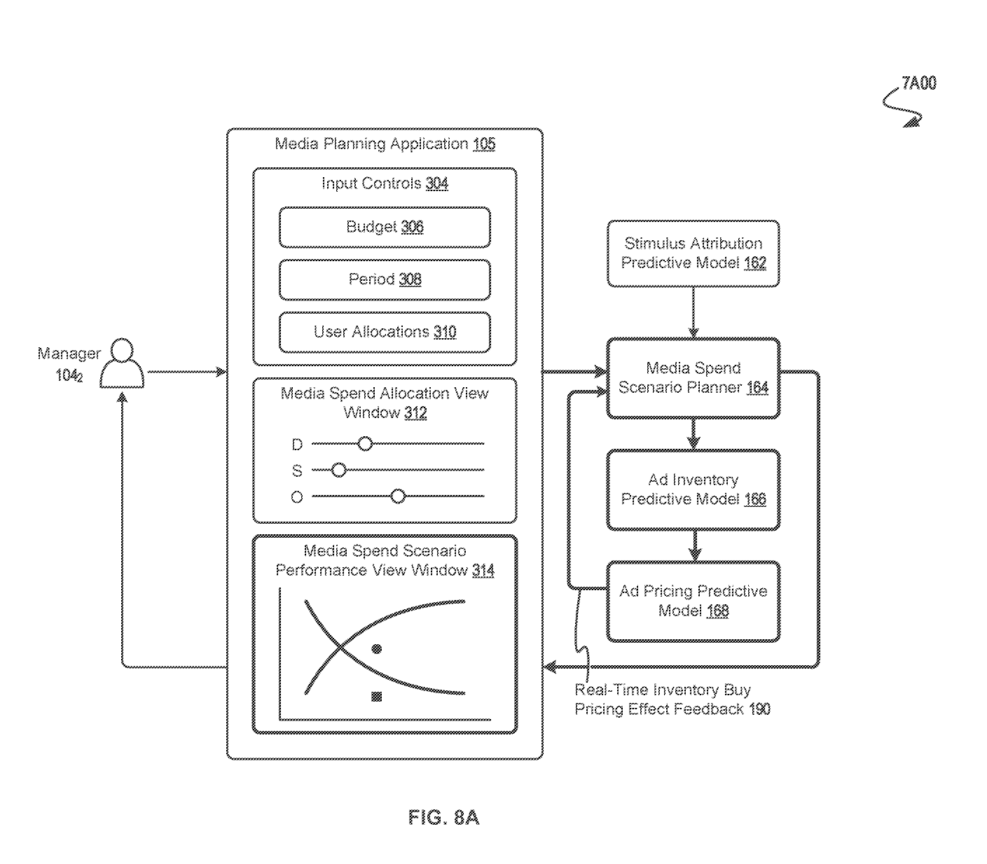

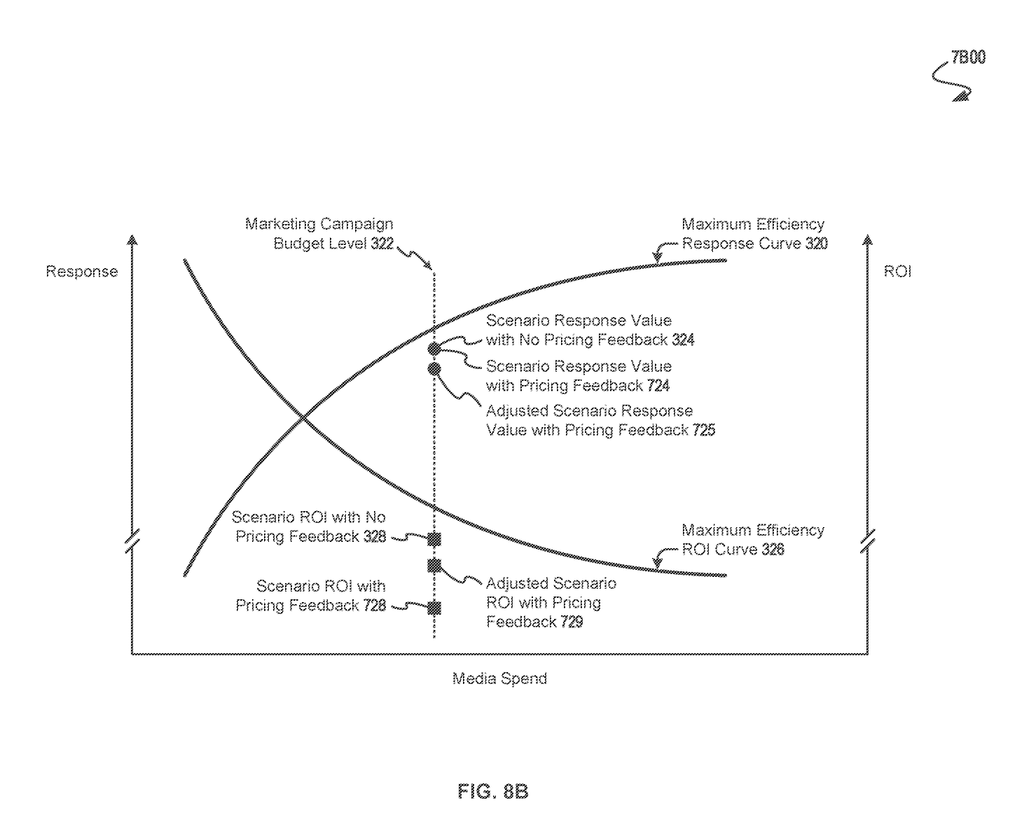

In one or more embodiments, the ad inventory predictive model 166 and the ad pricing predictive model 168 described in the foregoing can be used with stimulus attribution predictive model 162, the media spend scenario planner 164, and the media planning application 105 to improve media spend management using real-time predictive modeling of media spend effects on ad inventory pricing according to the herein disclosed techniques. Such an implementation is described as pertains to FIG. 8A.

FIG. 8A depicts a user interaction environment 7A00 for selecting and viewing predicted performance results of a media spend plan as displayed in a user interface to systems for improving media spend management using real-time predictive modeling of media spend effects on ad inventory pricing. As an option, one or more instances of user interaction environment 7A00 or any aspect thereof may be implemented in the context of the architecture and functionality of the embodiments described herein. Also, the user interaction environment 7A00 or any aspect thereof may be implemented in any desired environment.

The user interaction environment 7A00 comprises the stimulus attribution predictive model 162, the media spend scenario planner 164, the ad inventory predictive model 166, the ad pricing predictive model 168, and the media planning application 105 described in FIG. 1A and herein. According to one or more embodiments, the media planning application 105 can further comprise the input controls 304, the media spend allocation view window 312, and the media spend scenario performance view window 314 as described in FIG. 3A. As earlier described, the manager 104₂ can interact with the media planning application 105 to configure and/or invoke certain operations at the media spend scenario planner 164 to predict the performance of various media spend allocation scenarios. As further shown in the embodiment of FIG. 8A, the media spend scenario planner 164, the ad inventory predictive model 166, and the ad pricing predictive model 168 can be configured to implement the real-time inventory buy pricing effect feedback 190 according to the herein disclosed techniques. Such an implementation can enable the manager 104₂ to view the effect the purchase of certain ad inventory associated with a media spend allocation scenario has on the performance (e.g., ROI) of the ad inventory spend and/or the overall media spend allocation scenario. In exemplary cases, the media spend scenario performance view window 314 might present such performance effects as discussed in FIG. 8B.

FIG. 8B shows media spend scenario performance results 7B00 plotted in an interactive interface as implemented in systems for improving media spend management using real-time predictive modeling of media spend effects on ad inventory pricing. As an option, one or more instances of media spend scenario performance results 7B00 or any aspect thereof may be implemented in the context of the architecture and functionality of the embodiments described herein. Also, the media spend scenario performance results 7B00 or any aspect thereof may be implemented in any desired environment.

As shown, the media spend scenario performance results 7B00 comprises the maximum efficiency response curve 320, the maximum efficiency ROI curve 326, the marketing campaign budget level 322, the scenario response value with no pricing feedback 324, and the scenario ROI with no pricing feedback 328, as described as pertains to FIG. 3B. As further earlier described, the scenario response value with no pricing feedback 324 and the scenario ROI with no pricing feedback 328 might be produced by the media spend scenario planner 164 with no implementation of the real-time inventory buy pricing effect feedback 190 according to the herein disclosed techniques (e.g., see FIG. 3A). When implementing the herein disclosed techniques for improving media spend management using real-time predictive modeling of media spend effects on ad inventory pricing (e.g., see FIG. 8A), a scenario response value with pricing feedback 724 and a scenario ROI with pricing feedback 728 might be produced by the media spend scenario planner 164. In some cases, as shown, the real-time inventory buy pricing effect feedback 190 might not change the predicted response value (e.g., see scenario response value with no pricing feedback 324 and scenario response value with pricing feedback 724) since the response attributed to the stimuli comprising the ad inventory might not be affected by the purchase of the ad inventory. In comparison, the ROI can be impacted by the implementation of the real-time inventory buy pricing effect feedback 190 since the ad pricing can directly relate to the ROI value determination (e.g., compare the scenario ROI with no pricing feedback 328 and the scenario ROI with pricing feedback 728).

Using the herein disclosed techniques, a marketing manager can view a more accurate representation of the ROI (e.g., scenario ROI with pricing feedback 728) of the media spend allocation scenario. In some cases, the marketing manager can adjust the media spend allocation scenario in efforts to improve the ROI. Such an adjustment might reduce the response (e.g., to an adjusted scenario response value with pricing feedback 725), yet improve the ROI (e.g., to an adjusted scenario ROI with pricing feedback 729). After viewing the predicted performance results of other media spend allocation scenarios, the marketing manager might conclude that the adjusted scenario response value with pricing feedback 725 and the scenario ROI with pricing feedback 728 are acceptable given the marketing campaign budget level 322.

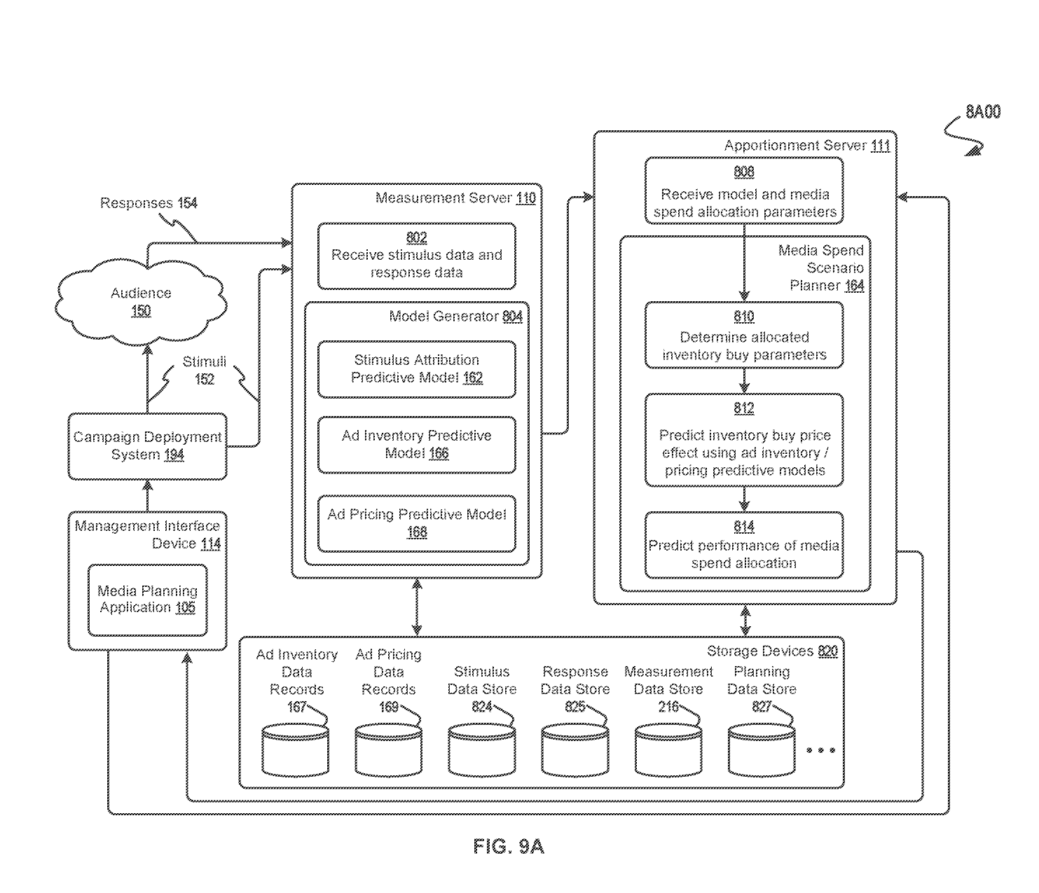

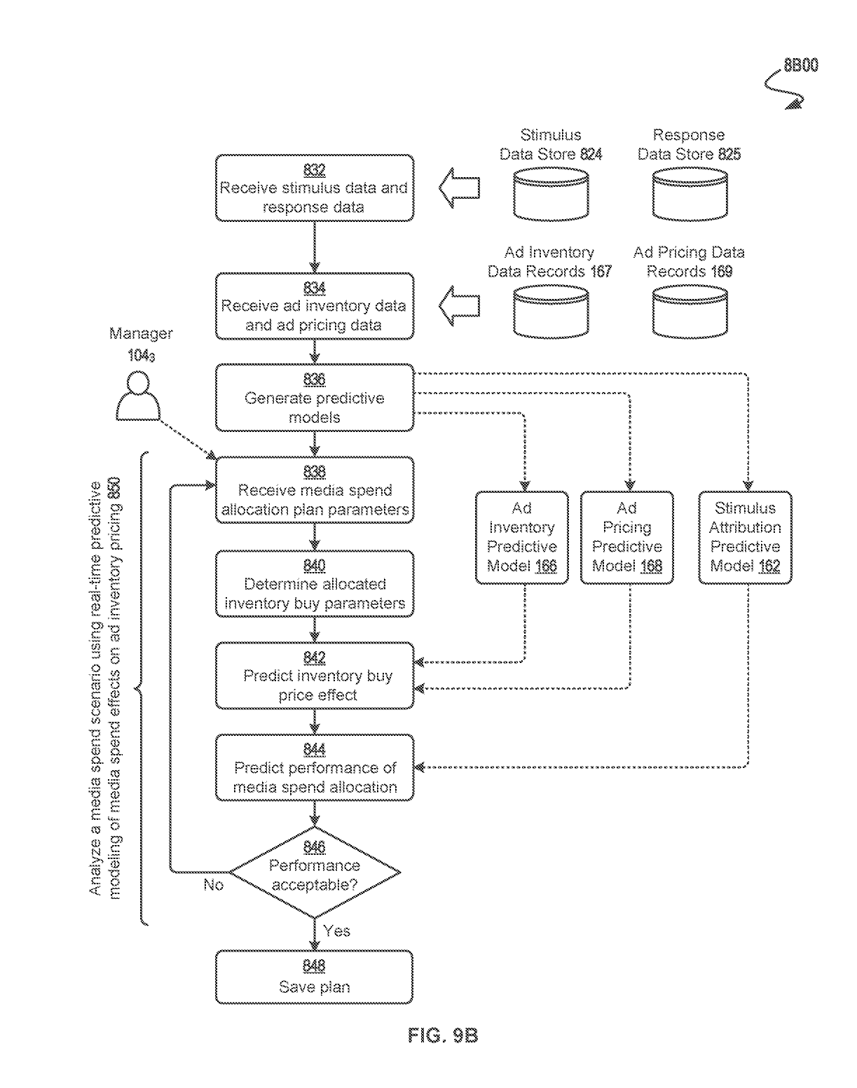

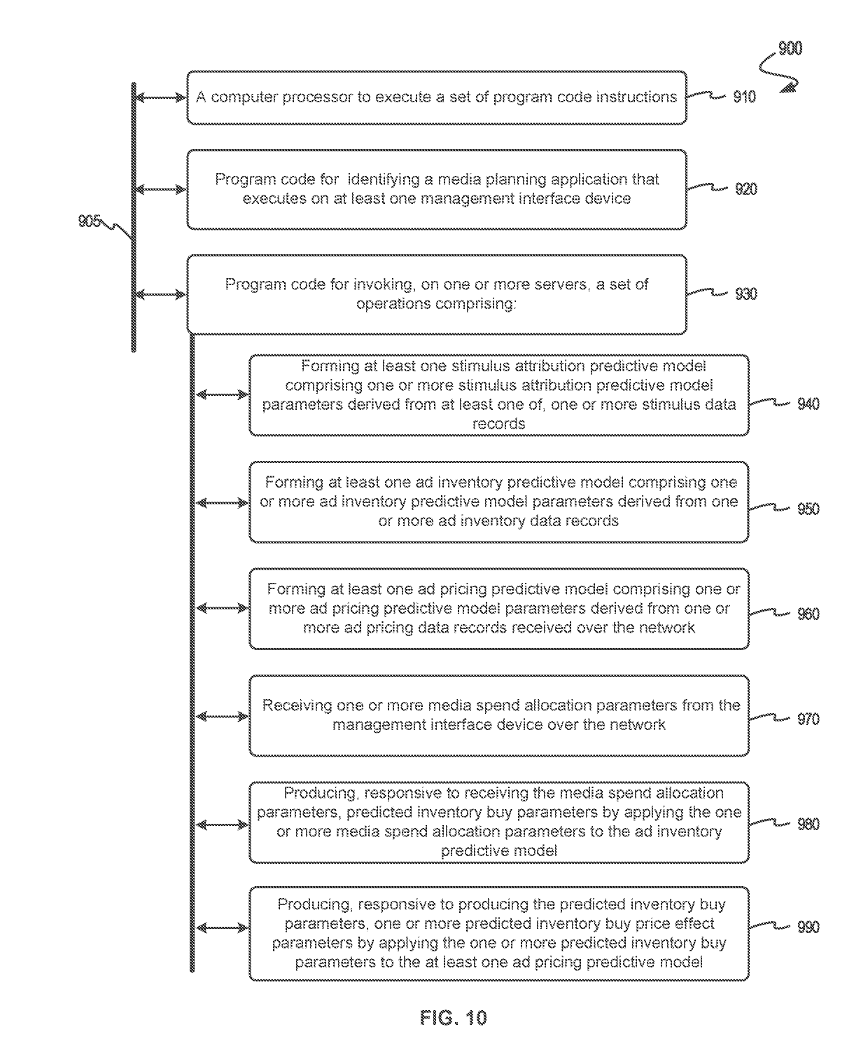

One embodiment of a subsystem for implementing the real-time inventory buy pricing effect feedback 190 and/or other herein disclosed techniques is discussed as pertains to FIG. 9A.

FIG. 9A depicts a subsystem 8A00 for improving media spend management using real-time predictive modeling of media spend effects on ad inventory pricing. As an option, one or more instances of subsystem 8A00 or any aspect thereof may be implemented in the context of the architecture and functionality of the embodiments described herein. Also, the subsystem 8A00 or any aspect thereof may be implemented in any desired environment.

As shown, subsystem 8A00 comprises certain components described in FIG. 1A and FIG. 1B. Specifically, the campaign deployment system 194 can present the stimuli 152 to the audience 150 to produce the responses 154. The measurement server 110 can receive electronic data records associated with the stimuli 152 and responses 154 (see operation 802). The stimulus data and response data can be stored in one or more storage devices 820 (e.g., stimulus data store 824, response data store 825, etc.). The measurement server 110 further comprises a model generator 804 that can use the stimulus data, response data, and/or other data to generate the stimulus attribution predictive model 162. In some embodiments, the model parameters (e.g., stimulus attribution predictive model parameters 222) characterizing the stimulus attribution predictive model 162 can be stored in the measurement data store 216. The model generator 804 can further use the ad inventory data records 167 and/or the ad pricing data records 169 to generate the ad inventory predictive model 166 and the ad pricing predictive model 168. In some embodiments, the ad inventory predictive model parameters 566 and the ad pricing predictive model parameters 668 characterizing the ad inventory predictive model 166 and the ad pricing predictive model 168, respectively, can be stored in the measurement data store 216.

As shown, the apportionment server 111 can receive the model parameters from the measurement server 110 and various instances of media spend allocation parameters from the management interface device 114 (see operation 808). For example, a user (e.g., marketing manager) might interact with the media planning application 105 on the management interface device 114 to specify and transmit the media spend allocation parameters (e.g., media spend allocation parameters 176) to the apportionment server 111. An instance of the media spend scenario planner 164 operating on the apportionment server 111 can determine instances of allocated inventory buy parameters (e.g., allocated inventory buy parameters 182) based in part on the media spend allocation parameters (see operation 810). The media spend scenario planner 164 can further predict the inventory buy price effect associated with the media spend scenario represented by the media spend allocation parameters using the ad inventory predictive model 166 and/or the ad pricing predictive model 168 (see operation 812). Such inventory buy price effects can then be included in the media spend allocation scenario performance predicted by the media spend scenario planner 164 (see operation 814). In one or more embodiments, the data representing the predicted media spend allocation scenario performance (e.g., predicted media spend allocation performance parameters 178) can be stored in a planning data store 827.

The subsystem 8A00 presents merely one partitioning. The specific example shown where the measurement server 110 comprises the model generator 804, and where the apportionment server 111 comprises the media spend scenario planner 164 is purely exemplary, and other partitioning is reasonable, and the partitioning may be defined in part by the volume of empirical data. In some cases, a database engine can serve to perform calculations (e.g., within, or in conjunction with, a database engine query) A technique for improving media spend management using real-time predictive modeling of media spend effects on ad inventory pricing can be implemented in accordance with the subsystems, flows, and partitioning choices as shown in FIG. 9B.

FIG. 9B is a flowchart 8B00 used in systems for improving media spend management using real-time predictive modeling of media spend effects on ad inventory pricing. As an option, one or more instances of flowchart 8B00 or any aspect thereof may be implemented in the context of the architecture and functionality of the embodiments described herein. Also, the flowchart 8B00 or any aspect thereof may be implemented in any desired environment.

The flowchart 8B00 presents one embodiment of certain steps for improving media spend management using real-time predictive modeling of media spend effects on ad inventory pricing. In one or more embodiments, the steps and underlying operations shown in the flowchart 8B00 can be executed by the measurement server 110 and apportionment server 111 disclosed herein. As shown, the flowchart 8B00 can commence with receiving stimulus data and response data from various sources (see step 832), such as the stimulus data store 824 and/or the response data store 825. Further, certain ad inventory data and ad pricing data can be received from various sources (see step 834), such as the ad inventory data records 167 and/or the ad pricing data records 169. Using the aforementioned received data and/or other data, various predictive models can be generated as disclosed herein (see step 836). For example, a stimulus attribution predictive model 162, an ad inventory predictive model 166, and an ad pricing predictive model 168 can be generated.

The flowchart 8B00 can continue with a set of steps for analyzing a media spend scenario using real-time predictive modeling of media spend effects on ad inventory pricing (see grouping 850). Such a set of steps might be invoked by a manager 104₃ as shown. Specifically, a set of media spend allocation parameters corresponding to a media spend allocation scenario can be received (see step 838). Various allocated inventory buy parameters can be determined in part from the received media spend allocation parameters (see step 840). An inventory buy price effect associated with the media spend scenario represented by the media spend allocation parameters can then be predicted using the ad inventory predictive model 166 and/or the ad pricing predictive model 168 (see step 842). Such inventory buy price effects can then be included in the predicted media spend allocation scenario performance (see step 844). If the predicted performance is not acceptable (see “No” path of decision 846), then an adjusted set of media spend allocation parameters can be specified (e.g., by the manager 104₃) and one or more of the steps comprising the grouping 850 can be repeated. When the predicted performance for a given media spend allocation scenario is acceptable (see “Yes” path of decision 846), the accepted media spend allocation scenario can be saved as a media spend plan for immediate and/or future deployment (see step 848).

### Additional Practical Application Examples

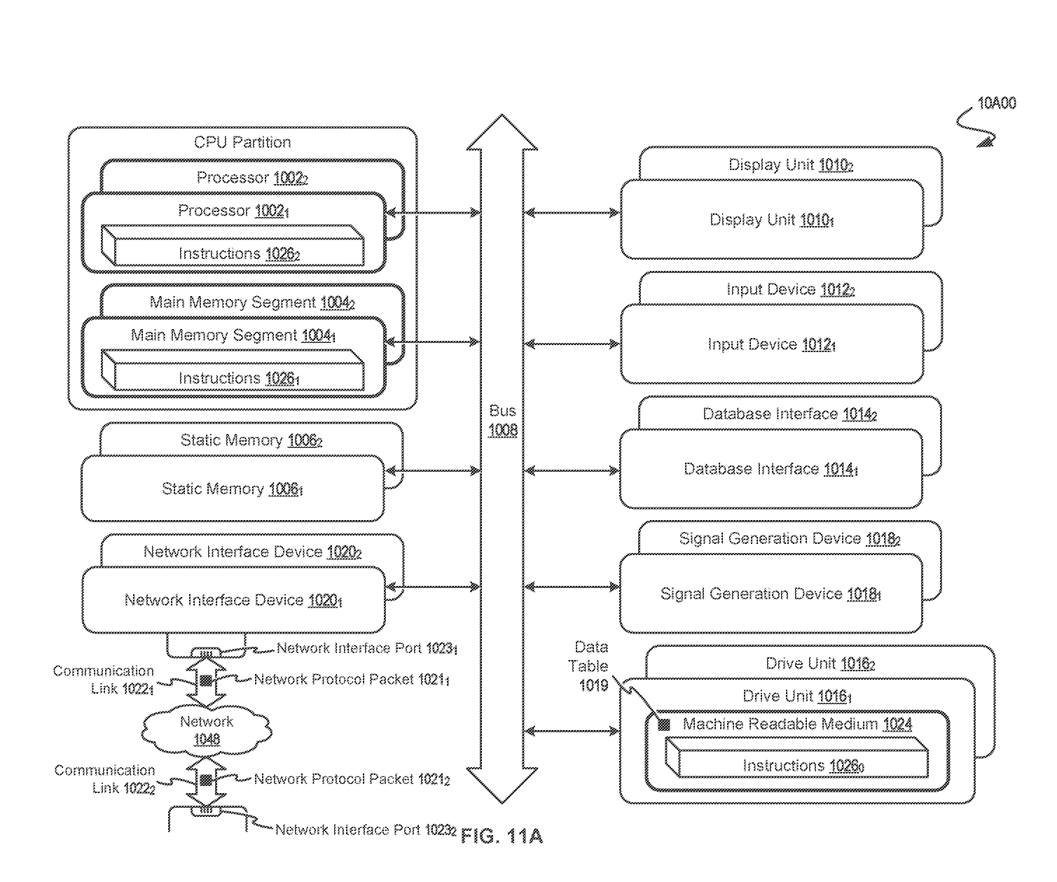

FIG. 10 is a block diagram of a system for improving media spend management using real-time predictive modeling of media spend effects on ad inventory pricing, according to an embodiment. As an option, the present system 900 may be implemented in the context of the architecture and functionality of the embodiments described herein. Of course, however, the system 900 or any operation therein may be carried out in any desired environment. The system 900 comprises at least one processor and at least one memory, the memory serving to store program instructions corresponding to the operations of the system. As shown, an operation can be implemented in whole or in part using program instructions accessible by a module. The modules are connected to a communication path 905, and any operation can communicate with other operations over communication path 905. The modules of the system can, individually or in combination, perform method operations within system 900. Any operations performed within system 900 may be performed in any order unless as may be specified in the claims. The shown embodiment implements a portion of a computer system, presented as system 900, comprising a computer processor to execute a set of program code instructions (see module 910) and modules for accessing memory to hold program code instructions to perform, identifying a media planning application that executes on at least one management interface device (see module 920); executing, on one or more servers, a set of operations (see module 930), the operations comprising:
forming at least one stimulus attribution predictive model comprising one or more stimulus attribution predictive model parameters derived from at least one of, one or more stimulus data records received over a first network path or one or more response data records, received over second network path (see module 940)
forming at least one ad inventory predictive model comprising one or more ad inventory predictive model parameters derived from one or more ad inventory data records (see module 950)
forming at least one ad pricing predictive model comprising one or more ad pricing predictive model parameters derived from one or more ad pricing data records received over the network (see module 960)
receiving one or more media spend allocation parameters from the management interface device over the network (see module 970)
producing, responsive to receiving the media spend allocation parameters, predicted inventory buy parameters by applying the one or more media spend allocation parameters to the ad inventory predictive model (see module 980), and
producing, responsive to producing the predicted inventory buy parameters, one or more predicted inventory buy price effect parameters by applying the one or more predicted inventory buy parameters to the at least one ad pricing predictive model (see module 990).

### Additional System Architecture Examples

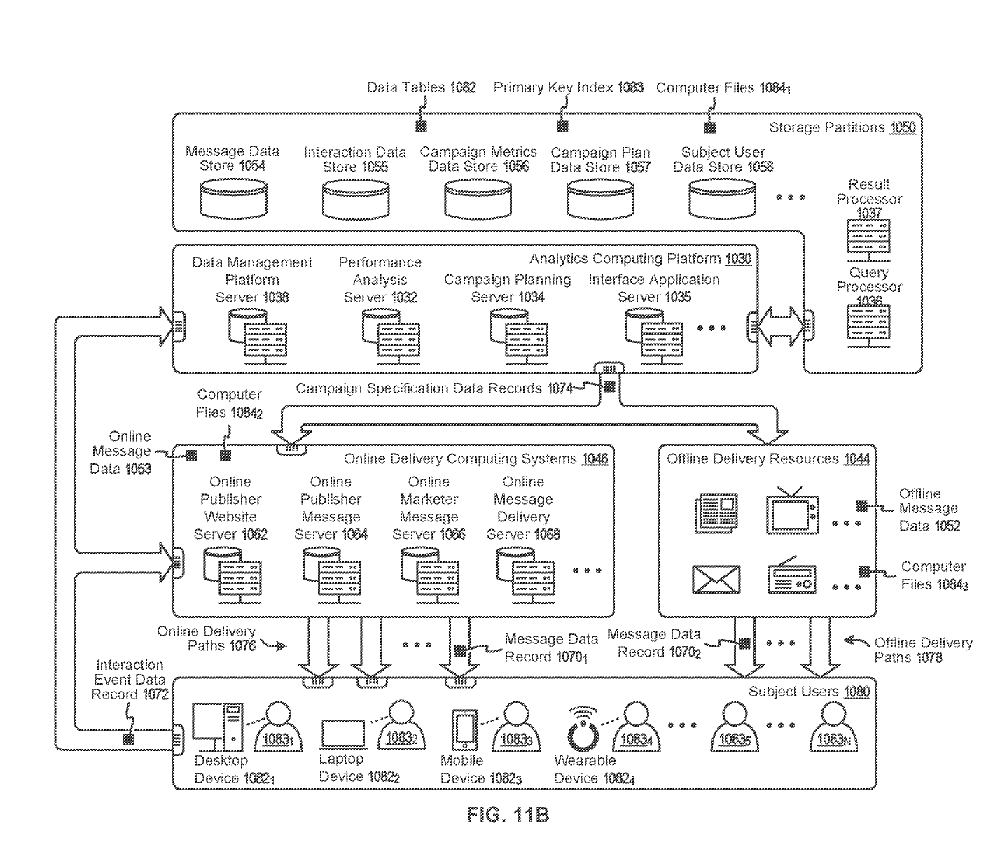

FIG. 11A depicts a diagrammatic representation of a machine in the exemplary form of a computer system 10A00 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 10A00 includes one or more processors (e.g., processor 1002₁ processor 1002₂, etc.), a main memory comprising one or more main memory segments (e.g., main memory segment 1004₁, main memory segment 1004₂, etc.), one or more static memories (e.g., static memory 1006₁, static memory 1006₂, etc.), which communicate with each other via a bus 1008. The computer system 10A00 may further include one or more video display units (e.g., display unit 1010₁, display unit 1010₂, etc.), such as an LED display, or a liquid crystal display (LCD), or a cathode ray tube (CRT). The computer system 10A00 can also include one or more input devices (e.g., input device 1012₁, input device 1012₂, alphanumeric input device, keyboard, pointing device, mouse, etc.), one or more database interfaces (e.g., database interface 1014₁, database interface 1014₂, etc.), one or more disk drive units (e.g., drive unit 1016₁, drive unit 1016₂, etc.), one or more signal generation devices (e.g., signal generation device 1018₁, signal generation device 1018₂, etc.), and one or more network interface devices (e.g., network interface device 1020₁, network interface device 1020₂, etc.).

The disk drive units can include one or more instances of a machine-readable medium 1024 on which is stored one or more instances of a data table 1019 to store electronic information records. The machine-readable medium 1024 can further store a set of instructions 1026₀ (e.g., software) embodying any one, or all, of the methodologies described above. A set of instructions 1026₁ can also be stored within the main memory (e.g., in main memory segment 1004₁). Further, a set of instructions 1026₂ can also be stored within the one or more processors (e.g., processor 1002₁). Such instructions and/or electronic information may further be transmitted or received via the network interface devices at one or more network interface ports (e.g., network interface port 1023₁, network interface port 1023₂, etc.). Specifically, the network interface devices can communicate electronic information across a network using one or more network paths, possibly including optical links. Ethernet links, wireline links, wireless links, and/or other electronic communication links (e.g., communication link 1022₁, communication link 1022₂, etc.). One or more network protocol packets (e.g., network protocol packet 1021₁, network protocol packet 1021₂, etc.) can be used to hold the electronic information (e.g., electronic data records) for transmission across an electronic communications network (e.g., network 1048). In some embodiments, the network 1048 may include, without limitation, the web (i.e., the Internet), one or more local area networks (LANs), one or more wide area networks (WANs), one or more wireless networks, and/or one or more cellular networks.

The computer system 10A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media, optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 1002₁, processor 1002₂, etc.).

FIG. 11B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 1048) using one or more electronic communication links (e.g., communication link 1022₁, communication link 1022₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 1023₁, network interface port 1023₂, etc.). In one or more embodiments, one or more network protocol packets (e.g., network protocol packet 1021₁, network protocol packet 1021₂, etc.) can be used to hold the electronic information comprising the signals.

As shown, the data processing system can be used by one or more advertisers to target a set of subject users 1080 (e.g., user 1083₁, user 1083₂, user 1083₃, user 1083₄, user 1083₅, to user 1083_{N}) in various marketing campaigns. The data processing system can further be used to determine, by an analytics computing platform 1030, various characteristics (e.g., performance metrics, etc.) of such marketing campaigns.

In some embodiments, the interaction event data record 1072 comprises bottom up data suitable for computing, in performance analysis server 1032, bottom up attribution. In other embodiments, the interaction event data record 1072 and offline message data 1052 comprise top down data suitable for computing, in performance analysis server 1032, top down attribution. In yet other embodiments, the interaction event data record 1072 and offline message data 1052 comprises data suitable for computing, in performance analysis server 1032, both bottom up and top down attribution.

The interaction event data record 1072 comprises, in part, a plurality of touchpoint encounters that represent the subject users 1080 exposure to marketing message(s). Each of these touchpoint encounters comprises a number of attributes, and each attribute comprises an attribute value. For example, the time of day during which the advertisement appeared, the frequency with which it was repeated, and the type of offer being advertised are all examples of attributes for a touchpoint encounter. Each attribute of a touchpoint may have a range of values. The attribute value range may be fixed or variable. For example, the range of attribute values for a day of the week attribute would be seven, whereas the range of values for a weather attribute may depend on the level of specificity desired. The attribute values may be objective (e.g., timestamp) or subjective (e.g., the relevance of the advertisement to the day's news cycle). For a “Publisher” attribute example (i.e., publisher of the marketing message), some examples of attribute values may be “Yahoo! Inc.”, “WSI com”, “Seeking Alpha”, “NY Times Online”, “CBS Matchwatch”, “MSN Money”, “CBS Interactive”, “YuMe” and “IH Remnant.”

The interaction event data record 1072 may pertain to various touchpoint encounters for an advertising or marketing campaign and the subject users 1080 who encountered each touchpoint. The interaction event data record 1072 may include entries that list each instance of a consumer's encounter with a touchpoint and whether or not that consumer converted. The interaction event data record 1072 may be gathered from a variety of sources, such as Internet advertising impressions and responses (e.g., instances of an advertisement being serve to a user and the user's response, such as clicking on the advertisement). Offline message data 1052, such as conversion data pertaining to television, radio, or print advertising, may be obtained from research and analytics agencies or other external entities that specialize in the collection of such data.

According to one embodiment, to compute bottom up attribution in performance analysis server 1032, the raw touchpoint and conversion data (e.g., interaction event data record 1072 and offline message data 1052) is prepared for analysis. For example, the data may be grouped according to touchpoint, user, campaign, or any other scheme that facilitates ease of analysis. All of the subject users 1080 that encountered the various touchpoints of a marketing campaign are identified. The subject users 1080 are divided between those who converted (i.e., performed a desired action as a result of the marketing campaign) and those who did not convert, and the attributes and attribute values of each touchpoint encountered by the subject users 1080 are identified. Similarly, all of the subject users 1080 that converted are identified. For each touchpoint encounter, this set of users is divided between those who encountered the touchpoint and those who did not. Using this data, the importance of each attribute of the various advertising touchpoints is determined, and the attributes of each touchpoint are ranked according to importance. Similarly, for each attribute and attribute value of each touchpoint, the likelihood that a potential value of that attribute might influence a conversion is determined.

According to some embodiments, attribute importance and attribute value importance may be modeled, using machine-learning techniques, to generate weights that are assigned to each attribute and attribute value, respectively. In some embodiments, the weights are determined by comparing data pertaining to converting users and non-converting users. In other embodiments, the attribute importance and attribute value importance may be determined by comparing conversions to the frequency of exposures to touchpoints with that attribute relative to others. In some embodiments, logistic regression techniques are used to determine the influence of each attribute and to determine the importance of each potential value of each attribute. Any machine-learning algorithm may be used without deviating from the spirit or scope of the invention.

An attribution algorithm is used and coefficients are assigned for the algorithm, respectively, using the attribute importance and attribute value importance weights. The attribution algorithm determines the relative effect of each touchpoint in influencing each conversion given the attribute weights and the attribute value weights. The attribution algorithm is executed using the coefficients or weights. According to one embodiment, for each conversion, the attribution algorithm outputs a score for every touchpoint that a user encountered prior to converting, wherein the score represents the touchpoint's relative influence on the user's decision to convert. The attribution algorithm, which calculates the contribution of the touchpoint to the conversion, may be expressed as a function of the attribute importance (e.g., attribute weights) and attribute value lift (e.g., attribute value weights):

Credit Fraction=Σₐ₌₁ⁿf(attribute importanceₐ,attribute value liftₐ).

wherein, “a” represents the attribute and “n” represents the number of attributes. Further details regarding a general approach to bottom up touchpoint attribution are described in U.S. application Ser. No. 13/492,493 (Attorney Docket No. VISQ.P0001) entitled, “A METHOD AND SYSTEM FOR DETERMINING TOUCHPOINT ATTRIBUTION”, filed Jun. 8, 2012, now U.S. Pat. No. 9,183,562, the contents of which are incorporated by reference in its entirety in this Application.

Performance analysis server 1032 may also perform top down attribution. In general, a top down predictive model is used to determine the effectiveness of marketing stimulations in a plurality of marketing channels included in a marketing campaign. Data (interaction event data record 1072 and Offline message data 1052), comprising a plurality of marketing stimulations and respective measured responses, is used to determine a set of cross-channel weights to apply to the respective measured responses, where the cross-channel weights are indicative of the influence that a particular stimulation applied to a first channel has on the measure responses of other channels. The cross-channel weights are used in calculating the effectiveness of a particular marketing stimulation over an entire marketing campaign. The marketing campaign may comprise stimulations quantified as a number of direct mail pieces, a number or frequency of TV spots, a number of web impressions, a number of coupons printed, etc.

The top down predictive model takes into account cross-channel influence from more spending. For example, the effect of spending more on TV ads might influence viewers to “log in” (e.g., to access a website) and take a survey or download a coupon. The top down predictive model also takes into account counter-intuitive cross-channel effects from a single channel model. For example, additional spending on a particular channel often suffers from measured diminishing returns (e.g., the audience “tunes out” after hearing a message too many times). Placement of a message can reach a “saturation point” beyond which point further desired behavior is not apparent in the measurements in the same channel. However additional spending beyond the single-channel saturation point may correlate to improvements in other channels.

One approach to advertising portfolio optimization uses marketing attributions and predictions determined from historical data (interaction event data record 1072 and Offline message data 1052). Analysis of the historical data serves to infer relationships between marketing stimulations and responses. In some cases, the historical data comes from “online” outlets, and is comprised of individual user-level data, where a direct cause-effect relationship between stimulations and responses can be verified. However; “offline” marketing channels, such as television advertising, are of a nature such that indirect measurements are used when developing models used in media spend optimization. For example, some stimuli are described as an aggregate (e.g., “TV spots on Prime Time News, Monday, Wednesday and Friday”) that merely provides a description of an event or events as a time-series of marketing stimulations (e.g., weekly television advertising spends). Responses to such stimuli are also often measured and/or presented in aggregate (e.g., weekly unit sales reports provided by the telephone sales center). Yet, correlations, and in some cases causality and inferences, between stimulations and responses can be determined via statistical methods.

The top down predictive model considers cross-channel effects even when direct measurements are not available. The top down predictive model may be formed using any machine learning techniques. Specifically, top down predictive model may be formed using techniques where variations (e.g., mixes) of stimuli are used with the learning model to capture predictions of what would happen if a particular portfolio variation were prosecuted. The learning model produces a set of predictions, one set of predictions for each variation. In this manner, variations of stimuli produce predicted responses, which are used in weighting and filtering, which in turn result in a simulated model being output that includes cross-channel predictive capabilities.

In one example, a portfolio schematic includes three types of media, namely TV, radio and print media. Each media type may have one or more spends. For example, TV may include stations named CH1 and CH2. Radio includes a station named KVIQ 212. Print media may comprise distribution in the form of mail, a magazine and/or a printed coupon. For each media, there is one or more stimulations (e.g., S1, S2, . . . SN) and its respective response (e.g., R1, R2, R3 . . . RN). There is a one-to-one correspondence between a particular stimulus and its response. The stimuli and responses discussed herein are often formed as a time-series of individual stimulations and responses, respectively. For notational convenience, a time-series is given as a vector, such as vector S1.

Continuing the discussion of the example portfolio, the portfolio includes spends for TV, such as the evening news, weekly series, and morning show. The portfolio also includes radio spends in the form of a sponsored public service announcement, a sponsored shock jock spot, and a contest. The example portfolio may further include spends for radio station KVIQ, a direct mailer, and magazine print ads (e.g., coupon placement). The portfolio also includes spends for print media in the form of coupons.

The example portfolio may be depicted as stimulus vectors (e.g., S1, S2, S3, S4, S5, S6, S7, S8, and S). The example portfolio may also show a set of response measurements to be taken, such as response vectors (e.g., R1, R2, R3, R4, R5, R6, R7, R8, and RN).

A vector S̅1̅ may be comprised of a time-series. The time-series may be presented in a native time unit (e.g., weekly, daily) and may be apportioned over a different time unit. For example, stimulus S1 corresponds to a weekly spend for “Prime Time News” even though the stimulus to be considered actually occurs nightly (e.g., during “Prime Time News”). The weekly spend stimulus can be apportioned to a nightly stimulus occurrence. In some situations, the time unit in a time-series can be very granular (e.g., by the minute). Apportioning can be performed using any known techniques. Stimulus vectors and response vectors can be formed from any time-series in any time units and can be apportioned to another time-series using any other time units.

A particular stimulus in a first marketing channel (e.g., S̅1̅) might produce corresponding results (e.g., R̅1̅). Additionally, a stimulus in a first marketing channel (e.g., S̅1̅) might produce results (or lack of results) as given by measured results in a different marketing channel (e.g., R̅3̅). Such correlation of results, or lack of results, can be automatically detected, and a scalar value representing the extent of correlation can be determined mathematically from any pair of vectors. In the discussions just below, the correlation of a time-series response vector is considered with respect to a time-series stimulus vector. Correlations can be positive (e.g., the time-series data moves in the same directions), or negative (e.g., the time-series data moves in the opposite directions), or zero (no correlation).

An example vector S̅1̅ is comprised of a series of changing values. The response R̅1̅ may be depicted as a curve. Maximum value correlation occurs when the curve is relatively time-shifted, by Δt amount of time, to another. The amount of correlation and amount of time shift can be automatically determined. Example cross-channel correlations are presented in Table 1.

TABLE 1
Cross-correlation examples

| Stimulus Channel →Cross- | |
|---|---|
| channel | Description |
| S1 → R2 | No correlation. |
| S1 → R3 | Correlates if time shifted and attenuated |
| S1 → R4 | Correlates if time shifted and amplified |

In some cases, a correlation calculation can identify a negative correlation where an increase in a first channel causes a decrease in a second channel. Further, in some cases, a correlation calculation can identify an inverse correlation where a large increase in a first channel causes a small increase in a second channel. In still further cases, there can be no observed correlation, or in some cases correlation is increased when exogenous variables are considered.

In some cases a correlation calculation can hypothesize one or more causation effects. And in some cases correlation conditions are considered when calculating correlation such that a priori known conditions can be included (or excluded) from the correlation calculations.

The automatic detection can proceed autonomously. In some cases correlation parameters are provided to handle specific correlation cases. In one case, the correlation between two time-series can be determined to a scalar value using Eq. 1.

$$r = \frac{n \sum xy - ( \sum x ) ( \sum y )}{\sqrt{n ( \sum {x}^{2} ) - {( \sum x )}^{2}} \sqrt{n ( \sum {y}^{2} ) - {( \sum y )}^{2}}} \qquad ( 1 )$$

where:
x represents components of a first time-series,
y represents components of a second time-series, and
n is the number of {x, y} pairs.

In some cases, while modeling a time-series, not all the scalar values in the time-series are weighted equally. For example, more recent time-series data values found in the historical data are given a higher weight as compared to older ones. Various shapes of weights to overlay a time-series are possible, and one exemplary shape is the shape of an exponentially decaying model.

Use of exogenous variables might involve considering seasonality factors or other factors that are hypothesized to impact, or known to impact, the measured responses. For example, suppose the notion of seasonality is defined using quarterly time graduations. And the measured data shows only one quarter (e.g., the 4^{th} quarter) from among a sequence of four quarters in which a significant deviation of a certain response is present in the measured data. In such a case, the exogenous variables 510 can define a variable that lumps the 1^{st} through 3^{rd} quarters into one variable and the 4^{th} quarter in a separate variable.

Further details of a top down predictive model are described in U.S. application Ser. No. 14/145,625 (Attorney Docket No. VISQ.P0004) entitled, “MEDIA SPEND OPTIMIZATION USING CROSS-CHANNEL PREDICTIVE MODEL”, filed Dec. 31, 2013, the contents of which are incorporated by reference in its entirety in this Application.

Other operations, transactions, and/or activities associated with the data processing system are possible. Specifically, the subject users 1080 can receive a plurality of online message data 1053 transmitted through any of a plurality of online delivery paths 1076 (e.g., online display, search, mobile ads, etc.) to various computing devices (e.g., desktop device 1082₁, laptop device 1082₂, mobile device 1082₃, and wearable device 1082₄). The subject users 1080 can further receive a plurality of offline message data 1052 presented through any of a plurality of offline delivery paths 1078 (e.g., TV, radio, print, direct mail, etc.). The online message data 1053 and/or the offline message data 1052 can be selected for delivery to the subject users 1080 based in part on certain instances of campaign specification data records 1074 (e.g., established by the advertisers and/or the analytics computing platform 1030). For example, the campaign specification data records 1074 might comprise settings, rules, taxonomies, and other information transmitted electronically to one or more instances of online delivery computing systems 1046 and/or one or more instances of offline delivery resources 1044. The online delivery computing systems 1046 and/or the offline delivery resources 1044 can receive and store such electronic information in the form of instances of computer files 1084₂ and computer files 1084₃, respectively in one or more embodiments, the online delivery computing systems 1046 can comprise computing resources such as an online publisher website server 1062, an online publisher message server 1064, an online marketer message server 1066, an online message delivery server 1068, and other computing resources. For example, the message data record 1070₁ presented to the subject users 1080 through the online delivery paths 1076 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 1070₂ presented to the subject users 1080 through the offline delivery paths 1078 can be transmitted as sensory signals in various forms (e.g., printed pictures and text, video, audio, etc.).

The analytics computing platform 1030 can receive instances of an interaction event data record 1072 comprising certain characteristics and attributes of the response of the subject users 1080 to the message data record 1070₁, the message data record 1070₂, and/or other received messages. For example, the interaction event data record 1072 can describe certain online actions taken by the users on the computing devices, such as visiting a certain URL, clicking a certain link, loading a web page that fires a certain advertising tag, completing an online purchase, and other actions. The interaction event data record 1072 may also include information pertaining to certain offline actions taken by the users, such as purchasing a product in a retail store, using a printed coupon, dialing a toll-free number, and other actions. The interaction event data record 1072 can be transmitted to the analytics computing platform 1030 across the communications links as instances of electronic data records using various protocols and structures. The interaction event data record 1072 can further comprise data (e.g., user identifier, computing device identifiers, timestamps, IP addresses, etc.) related to the users and/or the users' actions.

The interaction event data record 1072 and other data generated and used by the analytics computing platform 1030 can be stored in one or more storage partitions 1050 (e.g., message data store 1054, interaction data store 1055, campaign metrics data store 1056, campaign plan data store 1057, subject user data store 1058, etc.). The storage partitions 1050 can comprise one or more databases and/or other types of non-volatile storage facilities to store data in various formats and structures (e.g., data tables 1082, computer files 1084₁, etc.). The data stored in the storage partitions 1050 can be made accessible to the analytics computing platform 1030 by a query processor 1036 and a result processor 1037, which can use various means for accessing and presenting the data, such as a primary key index 1083 and/or other means. In one or more embodiments, the analytics computing platform 1030 can comprise a performance analysis server 1032 and a campaign planning server 1034. Operations performed by the performance analysis server 1032 and the campaign planning server 1034 can vary widely by embodiment. As an example, the performance analysis server 1032 can be used to analyze the messages presented to the users (e.g., message data record 1070₁ and message data record 1070₂) and the associated instances of the interaction event data record 1072 to determine various performance metrics associated with a marketing campaign, which metrics can be stored in the campaign metrics data store 1056 and/or used to generate various instances of the campaign specification data records 1074. Further, for example, the campaign planning server 1034 can be used to generate marketing campaign plans and associated marketing spend apportionments, which information can be stored in the campaign plan data store 1057 and/or used to generate various instances of the campaign specification data records 1074. Certain portions of the interaction event data record 1072 might further be used by a data management platform server 1038 in the analytics computing platform 1030 to determine various user attributes (e.g., behaviors, intent, demographics, device usage, etc.), which attributes can be stored in the subject user data store 1058 and/or used to generate various instances of the campaign specification data records 1074. One or more instances of an interface application server 1035 can execute various software applications that can manage and/or interact with the operations, transactions, data, and/or activities associated with the analytics computing platform 1030. For example, a marketing manager might interface with the interface application server 1035 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However; the ordering of many of the described process actions may be changed without affecting the scope or operation of the disclosure. The specification and drawings are, accordingly, to be regarded in an illustrative sense rather than in a restrictive sense.

What is claimed is:

1. A computer-implemented method for optimizing spend to deploy a plurality of messages through a network, comprising:
storing in a computer, stimuli data for a plurality of touchpoint encounters that represent a plurality of messages, transmitted through a network and exposed to a plurality of users, and a media spend associated with deploying the messages;
storing, in the computer platform, response data for the touchpoint encounters that records both positive and negative responses to the messages;
training, using machine-learning techniques in a computer, the stimuli data with the response data to generate an attribution predictive model that correlates an effectiveness of the media spend to the positive responses of the message;
generating, in a computer, an inventory predictive model that models a relationship between a quantity of inventory, measured over an inventory buy period, and time for at least one of the published locations, and outputs the relationship in a plurality of predicted inventory buy parameters;
generating, in a computer, a pricing predictive model that receives the predicted inventory buy parameters and predicts a price to deploy the message by generating a relationship between a price of publishing the message and the quantity of inventory for at least one of the published locations;
rendering, on a display of a user computer, from the touchpoint exposure predictive model, at least one scenario that depicts the positive responses to the messages as a function of the media spend on at least one of the published locations;
receiving, through an interface of the user computer, input to increase the media spend on at least one of the published locations; and
rendering, on the display of the user computer, from the message pricing predictive model, a modified scenario that depicts an updated effectiveness of the messages measured in the response as a function of the increase in the media spend of at least one of the published locations with the price predicted from the quantity of inventory.

2. The computer-implemented method as set forth in claim 1, wherein the messages exposed to a plurality of users comprise notification messages associated with an Internet of Things System.

3. The computer-implemented method as set forth in claim 1, wherein the messages exposed to a plurality of users comprise marketing messages deployed across a plurality of media channels.

4. The computer-implemented method as set forth in claim 2,
wherein generating, in a computer, a message inventory predictive model further comprises receiving ad inventory data records, from a plurality of ad inventory data sources, to model the relationship between the quantity of inventory and time.

5. The computer-implemented method as set forth in claim 2,
wherein generating, in a computer, a message pricing predictive model further comprises receiving ad pricing data records, from a plurality of ad pricing data sources, to predict the price.

6. The computer-implemented method as set forth in claim 5, wherein the ad pricing data records comprises historical pricing data.

7. The computer-implemented method as set forth in claim 1,
wherein rendering, on a display of a user computer, from the touchpoint exposure predictive model, at least one scenario that depicts an effectiveness of the messages measured in the response as a function of the media spend of at least one of the published locations comprises:
rendering, on a display of a user computer, a maximum efficiency response curve that depicts a maximum efficiency of the response across a range of media spend.

8. The computer-implemented method as set forth in claim 1,
wherein rendering, on a display of a user computer, from the touchpoint exposure predictive model, at least one scenario that depicts an effectiveness of the messages measured in the response as a function of the media spend of at least one of the published locations comprises:
rendering, on a display of a user computer, a maximum efficiency return-on-investment curve that depicts a maximum efficiency of return-on-investment across a range of media spend.

9. A computer readable medium, embodied in a non-transitory computer readable medium, the non-transitory computer readable medium having stored thereon a sequence of instructions which, when stored in memory and executed by a processor causes the processor to perform a set of acts, the acts comprising:
storing in a computer, stimuli data for a plurality of touchpoint encounters that represent a plurality of messages, transmitted through a network and exposed to a plurality of users, and a media spend associated with deploying the messages;
storing, in the computer platform, response data for the touchpoint encounters that records both positive and negative responses to the messages;
training, using machine-learning techniques in a computer, the stimuli data with the response data to generate an attribution predictive model that correlates an effectiveness of the media spend to the positive responses of the message;
generating, in a computer, an inventory predictive model that models a relationship between a quantity of inventory, measured over an inventory buy period, and time for at least one of the published locations, and outputs the relationship in a plurality of predicted inventory buy parameters;
generating, in a computer, a pricing predictive model that receives the predicted inventory buy parameters and predicts a price to deploy the message by generating a relationship between a price of publishing the message and the quantity of inventory for at least one of the published locations;
rendering, on a display of a user computer, from the touchpoint exposure predictive model, at least one scenario that depicts the positive responses to the messages as a function of the media spend on at least one of the published locations;
receiving, through an interface of the user computer, input to increase the media spend on at least one of the published locations; and
rendering, on the display of the user computer, from the message pricing predictive model, a modified scenario that depicts an updated effectiveness of the messages measured in the response as a function of the increase in the media spend of at least one of the published locations with the price predicted from the quantity of inventory.

10. The computer readable medium as set forth in claim 9, wherein the messages exposed to a plurality of users comprise notification messages associated with an Internet of Things System.

11. The computer readable medium as set forth in claim 9, wherein the messages exposed to a plurality of users comprise marketing messages deployed across a plurality of media channels.

12. The computer readable medium as set forth in claim 10, wherein generating, in a computer, a message inventory predictive model further comprises receiving ad inventory data records, from a plurality of ad inventory data sources, to model the relationship between the quantity of inventory and time.

13. The computer readable medium as set forth in claim 10, wherein generating, in a computer, a message pricing predictive model further comprises receiving ad pricing data records, from a plurality of ad pricing data sources, to predict the price.

14. The computer readable medium as set forth in claim 13, wherein the ad pricing data records comprises historical pricing data.

15. The computer readable medium as set forth in claim 9, wherein rendering, on a display of a user computer, from the touchpoint exposure predictive model, at least one scenario that depicts an effectiveness of the messages measured in the response as a function of the media spend of at least one of the published locations comprises:
rendering, on a display of a user computer, a maximum efficiency response curve that depicts a maximum efficiency of the response across a range of media spend.

16. The computer readable medium as set forth in claim 9, wherein rendering, on a display of a user computer, from the touchpoint exposure predictive model, at least one scenario that depicts an effectiveness of the messages measured in the response as a function of the media spend of at least one of the published locations comprises:
rendering, on a display of a user computer, a maximum efficiency return-on-investment curve that depicts a maximum efficiency of return-on-investment across a range of media spend.

17. A system comprising:
a storage medium, having stored thereon, a sequence of instructions;
at least one processor, coupled to the storage medium, that executes the instructions to cause the processor to perform a set of acts comprising:
storing in a computer, stimuli data for a plurality of touchpoint encounters that represent a plurality of messages, transmitted through a network and exposed to a plurality of users, and a media spend associated with deploying the messages;
storing, in the computer platform, response data for the touchpoint encounters that records both positive and negative responses to the messages;
training, using machine-learning techniques in a computer, the stimuli data with the response data to generate an attribution predictive model that correlates an effectiveness of the media spend to the positive responses of the message;
generating, in a computer, an inventory predictive model that models a relationship between a quantity of inventory, measured over an inventory buy period, and time for at least one of the published locations, and outputs the relationship in a plurality of predicted inventory buy parameters;
generating, in a computer, a pricing predictive model that receives the predicted inventory buy parameters and predicts a price to deploy the message by generating a relationship between a price of publishing the message and the quantity of inventory for at least one of the published locations;
rendering, on a display of a user computer, from the touchpoint exposure predictive model, at least one scenario that depicts the positive responses to the messages as a function of the media spend on at least one of the published locations;
receiving, through an interface of the user computer, input to increase the media spend on at least one of the published locations; and
rendering, on the display of the user computer, from the message pricing predictive model, a modified scenario that depicts an updated effectiveness of the messages measured in the response as a function of the increase in the media spend of at least one of the published locations with the price predicted from the quantity of inventory.

18. The system as set forth in claim 17, wherein the messages exposed to a plurality of users comprise notification messages associated with an Internet of Things System.

19. The system as set forth in claim 17, wherein the messages exposed to a plurality of users comprise marketing messages deployed across a plurality of media channels.

20. The system as set forth in claim 18, wherein generating, in a computer, a message inventory predictive model further comprises receiving ad inventory data records, from a plurality of ad inventory data sources, to model the relationship between the quantity of inventory and time.
